(19) United States
(12) Patent Application Publication
(10) Pub. No.: US 2026/0296885 A1
(43) Pub. Date: Oct. 1, 2026

(54) IODINE EXTRACTION FROM BRINES

(71) Applicant: Voyageur Pharmaceuticals Ltd, Calgary (CA)

(72) Inventor: Brian L. Mueller, Sugar Land, TX (US)

(21) Appl. No.: 19/704,274

(22) Filed: Jun. 10, 2026

Related U.S. Application Data
(63) Continuation of application No. 19/568,028, filed on Mar. 16, 2026.
(60) Provisional application No. 63/773,198, filed on Mar. 17, 2025.
(60) Provisional application No. 63/857,373, filed on Aug. 4, 2025.
(60) Provisional application No. 63/886,506, filed on Sep. 23, 2025.
(60) Provisional application No. 63/919,377, filed on Nov. 17, 2025.

(51) Int. Cl. C01B 7/14

(52) U.S. Cl. CPC C01B 7/14

(57) ABSTRACT

A method includes converting one or more ionic iodine compounds within an aqueous brine solution to elemental iodine (I₂) and passing the aqueous brine solution containing the elemental iodine through a solid non-ionic adsorption media, wherein the elemental iodine is adsorbed out of the aqueous brine solution onto the solid non-ionic adsorption media. The method further includes passing a non-polar displacement fluid through the solid non-ionic adsorption media that is loaded with the elemental iodine, wherein the elemental iodine releases from the non-ionic adsorption media and dissolves into the non-polar displacement fluid, and separating the elemental iodine from the non-polar displacement fluid.

### BACKGROUND

The present disclosure relates to systems and methods for obtaining elemental iodine (I₂) from aqueous brine solutions.

### BACKGROUND OF THE RELATED ART

Iodine (I) (also known as atomic iodine) is crucial for various industrial and medicinal uses. There is an increasing demand for iodine and its major derivatives, such as iodide salts. The consumption of iodine and iodide salts is distributed among several industrial applications, such as catalysts, animal feed additives, stabilizers for nylon resins, inks and colorants, pharmaceuticals, disinfectants, film, and other uses. A great deal of attention is therefore focused on the recovery of iodine from various sources, either as a primary product or as a by-product of other industrial processes.

Elemental iodine (I₂) is generally recovered by physical and/or chemical manipulation of an aqueous solution containing soluble iodine ions (“ionic iodine”) like iodide (I¹⁻) or iodate (IO₃¹⁻). The term “brine” includes industrial occurring salt solutions containing ionic iodine in various salt forms. However, the term “brine” also includes geological or naturally occurring waters that have been brought to the surface from underground sources. Non-limiting examples of brine include seawater and natural brines from petroleum deposits and salt dome mining. Some brines may contain, for example, potassium iodide (KI), sodium iodide (NAI), potassium iodate (KIO₃), sodium iodate (NaIO₃), calcium iodate (Ca(IO₃)₂), lithium iodide (LiI), and/or magnesium iodide (MgI₂).

### BRIEF SUMMARY

Some embodiments provide a method comprising converting one or more ionic iodine compounds within an aqueous brine solution to elemental iodine and passing the aqueous brine solution containing the elemental iodine through a solid non-ionic adsorption media, wherein the elemental iodine is adsorbed out of the aqueous brine solution onto the solid non-ionic adsorption media. The method further comprises passing a non-polar displacement fluid through the solid non-ionic adsorption media that is loaded with the elemental iodine, wherein the elemental iodine releases from the non-ionic adsorption media and dissolves into the non-polar displacement fluid, and separating the elemental iodine from the non-polar displacement fluid.

### BRIEF DESCRIPTION OF THE SEVERAL VIEWS OF THE DRAWINGS

FIG. 1 is a diagram of a system for processing an aqueous brine solution that contains ionic iodine and collecting a concentrated elemental iodine product according to some embodiments.

FIG. 2 is a diagram of a simplified system for processing an aqueous brine solution that contains ionic iodine and collecting a concentrated elemental iodine product according to some embodiments.

FIG. 3 is a schematic diagram of a surface of an adsorption material that is modified with one or more alkyl siloxy substituents according to some embodiments.

FIG. 4 is a graph illustrating the yield of elemental iodine diagram of a system or process for separating iodine from brine.

### DETAILED DESCRIPTION

Some embodiments provide a method comprising converting one or more ionic iodine compounds within an aqueous brine solution to elemental iodine and passing the aqueous brine solution containing the elemental iodine through a solid non-ionic adsorption media, wherein the elemental iodine is adsorbed out of the aqueous brine solution onto the solid non-ionic adsorption media. The method further comprises passing a non-polar displacement fluid through the solid non-ionic adsorption media that is loaded with the elemental iodine, wherein the elemental iodine releases from the non-ionic adsorption media and dissolves into the non-polar displacement fluid, and separating the elemental iodine from the non-polar displacement fluid.

Iodine is a chemical element (a halogen) having the symbol “I” and the atomic number 53. Iodine may exist in various forms of “ionic iodine compounds”, such as iodide (I¹⁻), iodite (IO₂¹⁻), and iodate (IO₃¹⁻), as well as a stable diatomic molecule referred to herein as “elemental iodine” (I₂). Aqueous brines contain significant amounts of ionic iodine compounds such as potassium iodide (KI), sodium iodide (NAI), lithium iodide (LiI), magnesium iodide (MgI₂). potassium iodate (KIO₃), sodium iodate (NaIO₃) and/or calcium iodate (Ca(IO₃)₂). However, it is a technical advantage of various embodiments that the ionic iodine compounds in an aqueous brine may be converted to elemental iodine (I₂) and then the elemental iodine (I₂) may be separated from the aqueous brine. Whereas the various ionic iodine compounds have a high solubility in the aqueous brine, elemental iodine (I₂) is a hydrophobic molecule having a low solubility in the aqueous brine.

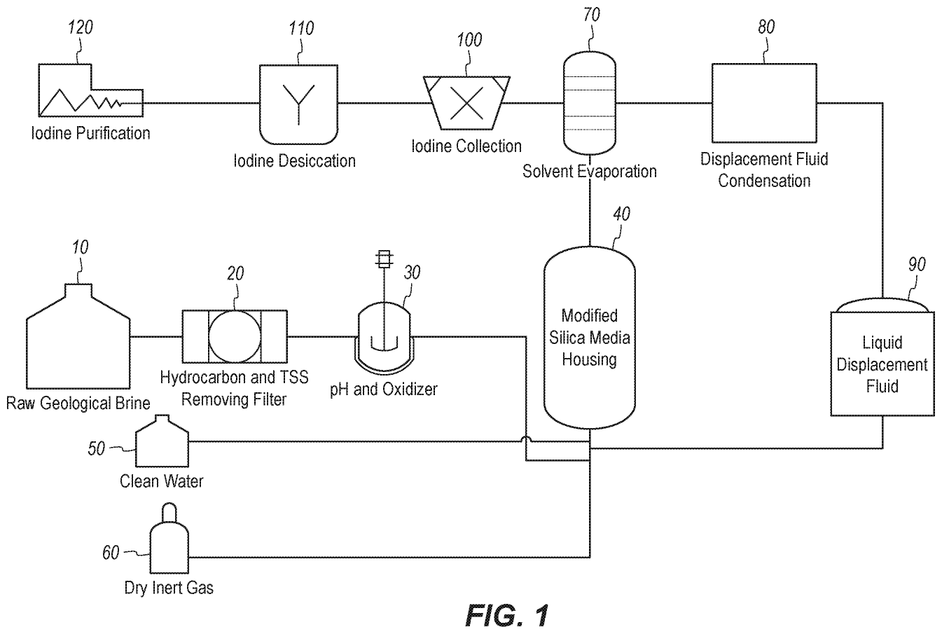

An “aqueous brine solution” (or simply referred to herein as “brine”) is a high-concentration mixture of salt dissolved in water. Without limitation, the incoming raw aqueous brine solution may be obtained from a producing oil and gas well, geothermal well, and/or saltwater disposal (SWD) gathering pipeline. The aqueous brine solution may also come from a blowout tower used to make an initial iodide upgrade (i.e., increase the iodide concentration). Furthermore, the brine may also be a recycled waste breakdown product where the iodide has been dissolved in water. Optionally, the brine provided as an input to the system may have been pretreated to remove any hydrocarbons that may be present in the brine. The source of brine may be, without limitation, any water that comes from underground geological formations that contain water and dissolvable minerals. The source of brine may be an active oil well, abandoned oil well, salt well, geothermal well and/or produced saltwater disposal well. Additional sources of brine are discussed in reference to the system of FIG. 1.

The non-polar displacement fluid is a solvent having a high solubility for elemental iodine (I₂) and a higher vapor pressure than elemental iodine (I₂). The non-polar displacement fluid needs to have a high solubility for elemental iodine (I₂) in order to dissolve the elemental iodine (I₂) off the solid non-ionic adsorption media to which the elemental iodine (I₂) has been adsorbed. So, as the non-polar displacement fluid is passed through a column or vessel filled with the non-ionic adsorption media that has been loaded with elemental iodine (I₂), the non-polar displacement fluid will cause the elemental iodine (I₂) to come off the media and dissolve into the non-polar displacement fluid. The non-polar displacement fluid should have a higher vapor pressure than elemental iodine (I₂) in order to facilitate separation of the elemental iodine (I₂) from the non-polar displacement fluid. Specifically, the non-polar displacement fluid should vaporize at a temperature and/or pressure that allow for the non-polar displacement fluid to be selectively removed or separated from the elemental iodine (I₂). For example, the non-polar displacement fluid should have a boiling point lower than the sublimation temperature for iodine. In one option, the non-polar displacement fluid may have a boiling point below 200° F. at ambient pressure or, more preferably, a boiling point below 150° F. at ambient pressure. In other words, the non-polar displacement fluid should separate from the elemental iodine (I₂) in a distillation process with no more than a minimal carry-over of elemental iodine (I₂) in the non-polar displacement fluid. Finally, the non-polar displacement fluid should have no signification reactions with elemental iodine (I₂) (i.e., should be minimally reactive with elemental iodine (I₂) under the conditions of the adsorption, displacement and separation. Non-limiting examples of the non-polar displacement fluid may include, either alone or in combination, diethyl ether, methyl tert-butyl ether, ethyl acetate, methyl acetate, dimethyl ether, methyl ethyl ether, tetrahydrofuran, dichloromethane, tetrachloromethane, propane, butane, pentane or hexane, chloroethane, carbon tetrachloride, ethanol, acetone, methyl ethyl ketone, diethyl ketone, t-butyl acetate, ethyl acetate, xylene, toluene and d-limonene. Preferred non-polar displacement fluids include methyl acetate, methyl ether and diethyl ether.

The solid non-ionic adsorption media is a hydrophobic material capable of adsorbing or extracting non-polar compounds from an aqueous stream. The solid non-ionic adsorption media may be made into particles with various particle sizes or distributions and preferably has a high surface area per unit of volume of the media to increase or maximize the adsorption capacity of the solid non-ionic adsorption media for elemental iodine (I₂). In some options, the adsorption material is a swellable hydrophobic material that has been designed specifically for sorbing or extracting a non-polar compound from an aqueous stream. A non-polar compound has an even distribution of charge due to equal electron sharing. All non-polar compounds are nonionic (covalent). In some embodiments, solid non-ionic adsorption media may include a polymeric material such as a butadiene, epoxy, poly urea, polyurethane, siloxane, organosiloxane or styrene backbone functionalized with aromatic or aryl groups. The aromatic or aryl groups may be further modified with bromine or iodine. Additional characterization of solid non-ionic adsorption media and specific examples of solid non-ionic adsorption media are provided herein. As used herein, the term “sorbate” refers to a material that builds up on the surface of another substance during sorption. In the present embodiments, the sorbate is elemental iodine (I₂) and the material having a surface where the sorbate builds up is the solid non-ionic adsorption media.

A known measurement useful to quantify the thermodynamic preference of a hydrophobic substance to adsorb on a hydrophobic, solid material media is “octanol water separation factor” (K_{ow}). K_{ow} is an n-octanol-water partition coefficient or ratio for a two-phase system consisting of n-octanol and water. K_{ow} serves as a measure of the relationship between lipophilicity (fat solubility) and hydrophilicity (water solubility) of a substance. The value of K_{ow} is greater than one (K_{ow}>1) if a substance is more soluble in fat-like solvents such as n-octanol (i.e., the ratio of the substance's concentration at equilibrium is higher in the n-octanol than in the water), and the value of K_{ow} is less than one (K_{ow}<1) if the substance is more soluble in water than in the n-octanol (i.e., the ratio of the substance's concentration at equilibrium is higher in the water than in the n-octanol). So, a substance (the sorbate) with a higher K_{ow} value will have a stronger affinity to adsorb on hydrophobic (lipophilic) media, such as the solid non-ionic adsorption media described herein, than another substance with a lower K_{ow} value. Typically, a hydrophobic substance, such as elemental iodine (I₂), will have a high K_{ow} making selective adsorption on a hydrophobic media possible. The adsorption process is especially effective where the sorbate has log K_{ow}>1.25. Elemental iodine (I₂) has a K_{ow} of from 1.8 to 2.49, so elemental iodine (I₂) will adsorb well on the solid non-ionic adsorption media described herein, which are hydrophobic (lipophilic). The K_{ow} value always refers to only a single species or substance, such as elemental iodine (I₂), and may be calculated as: K_{ow}=log Cₒ/C_{w}; where Cₒ is the concentration of a substance in the octanol-rich phase and where C_{w} is the concentration of the substance in the water-rich phase.

In some embodiments, the method may further comprise removing suspended solids, iron compounds, and/or water insoluble hydrocarbons from the aqueous brine solution prior to converting the one or more ionic iodine compounds within the aqueous brine solution to elemental iodine. The suspended solids and/or water insoluble hydrocarbons may be physical and/or chemical means. In one example, the suspended solids and/or water insoluble hydrocarbons may be removed from the aqueous brine solution by forming a positive oxidation-reduction potential (ORP) by the addition of oxidizer such as peroxide, bleach or other common oxidizer within the aqueous brine solution. If needed a base such as sodium hydroxide can be added causing the aqueous brine solution to have pH is greater than 5.5, preferably greater than 6.0, and more preferably greater than 6.5. This step converts all soluble iron(II) to iron(III) oxidation state and creates a solid iron hydroxide/iron oxide which can be removed by physical means. This is preferably followed by clarifying the aqueous brine solution by flotation, settling, microfiltration and/or ultrafiltration after forming the positive oxidation-reduction potential and causing the aqueous brine solution to have a pH greater than 6.0. The aqueous brine solution may be filtered in various ways. In one option, the aqueous brine solution is filtered to less than 0.1 microns. In another option, the aqueous brine solution is filtered to less than 60 nanometers.

In some embodiments, the one or more ionic iodine compounds within the aqueous brine solution may be converted to elemental iodine (I₂) by adding an acid to the aqueous brine solution to cause the aqueous brine solution to have a pH less than 4.5 and adding an oxidizer into the aqueous brine solution. Accordingly, the pH less than 4.5 and the oxidizer cause the one or more ionic iodine compounds within the aqueous brine solution to be converted to elemental iodine (I₂). If the method includes a filtration operation, then the filtration operation preferably occurs prior to converting the one or more ionic iodine compounds within the aqueous brine solution to elemental iodine (I₂). In one option, the pH of the aqueous brine solution may be adjusted to within the range of about 0 to about 5.5, preferably within the range of about 0 to about 4 or, more preferably, in the range of about 1.0 to about 2.5. The pH may be adjusted or controlled by adding an acid, such as hydrochloric acid or sulfuric acid, to the aqueous brine solution, which may be held or passed through a water holding tank, reactor or a static mixing pipe.

In some embodiments, the oxidizer may be hypochlorous acid, sodium hypochlorite, hydrogen peroxide, ozone, chlorine dioxide, and/or peracetic acid. The hypochlorous acid or sodium hypochlorite can be generated electrolytically from the aqueous solution containing iodide or in a separate electrolytic cell. Typically, hypochlorite is shipped and used as “bleach” or a sodium hypochlorite solution. The oxidizer may be added, either by chemical addition or electrolytic generation, at 1 to 5 times the stoichiometric amount necessary to convert the ionic iodine compounds in the aqueous brine solution to elemental iodine (I₂) because of the slow kinetics of this conversion reaction. Even higher levels of oxidizer will speed up the reaction and offer a window of opportunity to extract the iodine at >90% yield. However, with more than 2 to 5 times the stoichiometric amount needed, the elemental iodine (I₂) may need to be extracted within a certain amount of time following addition of the oxidizer to avoid undesired side reactions, such as a side reaction converting elemental iodine (I₂) to iodate (IO₃¹⁻) or iodite (IO₂¹⁻). Furthermore, the amount of oxidizer may be adjusted to speed up the oxidation reaction to achieve a desired residence time (i.e., contact time between the oxidizer and the ionic iodine compounds in the aqueous brine solution) prior to introducing the aqueous brine solution into the adsorption media. In a further option, the one or more ionic iodine compounds within the aqueous brine solution may be electrolytically converted to elemental iodine (I₂) within the aqueous brine solution.

In some embodiments, the solid non-ionic adsorption media may be contained in a vessel or column through which the aqueous brine solution is passed. The adsorption media can be made of particles with various particle sizes and with a high surface area to increase or maximize the adsorption capacity of the solid non-ionic adsorption media for elemental iodine (I₂). The elemental iodine (I₂) has a yellow-orange color when in an aqueous brine. The solid non-ionic adsorption media is typically white or tan, but this color will change to the dark yellow-orange color as the media adsorbs the elemental iodine (I₂) out of the aqueous brine solution. The aqueous brine solution coming out of the other end of the column (i.e., the effluent) will be clear, showing the complete removal of the desired elemental iodine (I₂) from the brine. The flow of the aqueous brine solution can be from top to bottom of the column, from bottom to top of the column or sideways through the column (vertical or horizontal). In addition, particle size and particle size distribution of the solid non-ionic adsorption media can be optimized for packing density, preventing channeling of the brine flow, and/or retention within the column. In one option, the aqueous brine solution containing elemental iodine (I₂) may be passed through the column containing the solid non-ionic adsorption media to adsorb the elemental iodine (I₂) from the aqueous brine solution until the solid non-ionic adsorption media is saturated with elemental iodine (I₂).

In some embodiments, the method may further comprise rinsing the solid non-ionic adsorption media that is loaded with elemental iodine with clean water to remove ionic and water-soluble impurities from the solid non-ionic adsorption media. The solid non-ionic adsorption media becomes exposed to these ionic and water-soluble impurities when the aqueous brine solution passed through the solid non-ionic adsorption media and some amounts may remain when the flow of aqueous brine solution is stopped and perhaps even drained from the solid non-ionic adsorption media. While the clean water removes the ionic and water soluble impurities, elemental iodine (I₂) is essentially insoluble in water, such that (in an optional operation) the clean water can flow through the solid non-ionic adsorption media without disturbing the adsorbed elemental iodine (I₂). However, the clean water rinse leaves the elemental iodine (I₂) and the solid non-ionic adsorption media in wet conditions. So, the method may further comprise passing a dry inert gas through the solid non-ionic adsorption media to remove water that remains on the solid non-ionic adsorption media after rinsing the solid non-ionic adsorption media. The solid non-ionic adsorption media that is loaded with elemental iodine is preferably rinsed and dried prior to passing the non-polar displacement fluid through the solid non-ionic adsorption media. Removing water from the solid non-ionic adsorption media prior to introducing the non-polar displacement fluid may increase the efficiency of the overall process because water removal at this stage may reduce or eliminate the amount of purification required later on in the process.

In some embodiments, the elemental iodine may be separated from the non-polar displacement fluid by vaporizing the displacement fluid without vaporizing the elemental iodine and removing the vaporized displacement fluid from contact with the elemental iodine. The remaining elemental iodine may be collected and further processed. Specifically, the elemental iodine may be fully vaporized at a higher temperature (i.e., higher than the temperature at which the displacement fluid was vaporized) once all the displacement fluid has been evaporated. This step will achieve a purer iodine product since any non-volatile impurities will not be vaporized. The elemental iodine vapor will then be condensed or deposited on a cooler surface such as a cold finger or plate. For example, the elemental iodine deposits may be in the form a crystals or flakes. In some embodiments, the non-polar displacement liquid containing the elemental iodine may be transferred to a distillation apparatus and the non-polar displacement liquid is fully vaporized. In some options, the distillation may include some heating due to the cooling effect of the evaporating displacement fluid and/or the distillation may optionally be performed under a reduced pressure provided by a vacuum device. For example, wherein the non-polar displacement fluid is diethyl ether or methyl acetate, and the sorbate is elemental iodine, the diethyl ether or methyl acetate may simply be allowed to vaporize leaving the elemental iodine behind.

In some embodiments, the method may further comprise condensing the vaporized displacement fluid in a separate vessel from the elemental iodine. The condensed non-polar displacement fluid that is collected in the separate vessel may be recycled for subsequent use to be passed through the solid non-ionic adsorption media. The non-polar displacement fluid is preferably collected, stored and recycled and used over numerous iterations or batches to dissolve adsorbed elemental iodine from the solid non-ionic adsorption media.

In some embodiments, the method may further comprise processing, after separating the elemental iodine from the non-polar displacement fluid, the separated elemental iodine by desiccation and/or sublimation to increase purity of the elemental iodine. For example, the elemental iodine may still be wet after separation from the non-polar displacement fluid. Accordingly, the wet iodine may be exposed to a desiccant to physically remove the water. This desiccation can be performed at a temperature where the elemental iodine melts and the desiccant is sulfuric acid or flowed over calcium sulfate, calcium chloride, silica gel molecular sieve or other common desiccant. This dry iodine can be converted to crystals or subjected to further purification. For example, the elemental iodine can be further processed by repeated operations of vaporization and re-sublimation to increase the purity. In one option, vaporized elemental iodine may be passed into a sublimation chamber with a cooling element, such as cooling fingers, plates or walls. The cooling element is cooled sufficiently to sublime the iodine on the surface in crystalline form. The stream can then be flowed through a fractional distillation column where several different temperature zones are maintained. Each zone can be controlled to selectively condense inorganic and organic constituents that were adsorbed along with the iodine. These purified streams can be selectively collected for sale.

In some embodiments, the method may further comprise warming, after separating the elemental iodine from the non-polar displacement fluid, the separated elemental iodine to a temperature greater than a sublimation temperature of elemental iodine to cause the elemental iodine to sublime away from residual water and/or non-volatile impurities and form an elemental iodine vapor. The method may then cool the elemental iodine vapor to a temperature less than the sublimation temperature of the elemental iodine to condense the elemental iodine as a solid. The condensed solid elemental iodine may then have a greater purity than the elemental iodine prior to forming the elemental iodine vapor. In one option, the solid elemental iodine may have a purity greater than 85 percent. The solid elemental iodine may be scraped or gathered from the sublimation chamber and packaged as iodine crystals or flakes.

In some embodiments, the extracted molecular iodine is processed to form solid iodine prill through a sequence of desiccation, sublimation, and controlled condensation. This prill production integrates seamlessly with the adsorption and displacement operations, enabling a closed-loop system that minimizes environmental impact and supports zero liquid discharge. The process is particularly advantageous for brines from iodine-enriched geological formations. In one example, a step-by-step method for producing iodine prill comprises: (a) pre-treating the brine to remove particulates and hydrocarbons using ultrafiltration (e.g., 0.06 μm pore size); (b) oxidizing ionic iodine compounds such as iodide to elemental iodine (I₂) with hypochlorous acid (HOCl) at pH 4-5, which may achieve >98% conversion; (c) adsorbing the elemental iodine (I₂) onto regenerable hydrophobic media (e.g., brominated polystyrene-divinylbenzene resin), which may be disposed in dual columns for continuous operation; (d) displacing adsorbed elemental iodine (I) with a low-boiling solvent (e.g., methyl acetate) and recovering the solvent via vacuum distillation (>95% yield), yielding crude elemental iodine (I₂); (e) desiccating the crude elemental iodine (I) under vacuum, such as at 50° C. and 0.1 bar to achieve <0.5% moisture; (f) subliming the desiccated elemental iodine (I₂), such as at 80-100° C. and 0.05 bar, and condensing the vapors in a prilling tower, such as at 20-30° C. with an inert gas purge, to form prill (1-3 mm diameter); and (g) recycling effluents, solvents, and unreacted components for closed-loop efficiency. In one option, these operations may provide >95% overall yield from crude elemental iodine (I₂), with prill purity >99% as confirmed by titration. Some embodiments may utilize alternative solvents (e.g., ethyl acetate) and/or alternative media (e.g., Dianion HP20).

In some embodiments, the non-ionic adsorption media is made of a polymeric substrate having aromatic groups and/or functionalized aromatic groups. For example, the non-ionic adsorption media may include a styrene divinylbenzene polymer. In a further example, the styrene divinylbenzene polymer may be functionalized with bromine. Still further, the non-ionic media may have a pore size between 50 and 500 angstroms and may have a specific surface area that is greater than 300 square meters per gram (m²/g).

In some embodiments, the non-ionic adsorption media includes silica media having a surface that has been modified with an alkyl siloxy substituent. For example, the alkyl siloxy substituent may be characterized by the formula: —Oₓ—Si—R_{y} where each R is independently selected from a branched, linear or aromatic hydrocarbon containing up to about 30 carbons, x is 1 or 2, y is 2 or 3, and the sum of x and y is equal to 4. Optionally, the surface modified silica media may be formed by modifying a silica material with one or more chloro-silanes.

In some embodiments, the method may further comprise monitoring a concentration of elemental iodine in an effluent brine solution that has been passed through the solid non-ionic adsorption media. Accordingly, the aqueous brine solution containing the elemental iodine may continue to be passed through the solid non-ionic adsorption media until the concentration of elemental iodine in the effluent brine solution exceeds an elemental iodine concentration setpoint. In one option, the concentration of the elemental iodine in the aqueous solution may be measured with a spectrophotometer.

In some embodiments, after removing the elemental iodine from the solid non-ionic adsorption media, the solid non-ionic adsorption media may be used again to adsorb additional elemental iodine from another quantity of the aqueous brine solution. For the example, after passing the non-polar displacement fluid through the solid non-ionic adsorption media that is loaded with the elemental iodine to release the elemental iodine from the non-ionic adsorption media and dissolve the elemental iodine into the non-polar displacement fluid, the method may further include passing an additional amount of the aqueous brine solution containing the elemental iodine through the solid non-ionic adsorption media. Accordingly, an additional amount of the elemental iodine is adsorbed out of the additional amount of aqueous brine solution onto the solid non-ionic adsorption media. It is a technical advantage of some embodiments that non-ionic adsorption media may be used repeatedly to extract additional amounts of element iodine from the aqueous brine solution.

In some embodiments, the solid non-ionic adsorption media may be contained in first and second vessels, columns, chambers or units. Accordingly, the aqueous brine solution containing the elemental iodine may be passed through the solid non-ionic adsorption media in the first vessel while other processes are occurring in the second vessel. Subsequently, the aqueous brine solution containing the elemental iodine may be passed through the solid non-ionic adsorption media in the second vessel while other processes are occurring in the first vessel. Without limitation, those other processes may include, rinsing the solid non-ionic adsorption media with clean water, drying the solid non-ionic adsorption media with an inert gas, and/or passing the non-polar displacement fluid through the solid non-ionic adsorption media that is loaded with the elemental iodine. Embodiments may include any number of adsorption vessels, columns or units. When one or more adsorption vessels are in a loading stage where elemental iodine is being adsorbed onto the non-ionic adsorption media, one or more other adsorption vessels may be in a desorption/displacement stage wherein the elemental iodine is being released from the non-ionic adsorption media. Since the aqueous brine solution containing elemental iodine does not flow through the adsorption vessel during a desorption/displacement stage, each adsorption vessel is run intermittently or in batches. This limitation may be accommodated by configuring the system with multiple adsorption vessels, such as from 2 to 9 of these adsorption columns or chambers, so there is always one or more columns (such as at least 1 to 3 columns) loading elemental iodine from the aqueous brine solution while there is always one or more columns (such as at least 1 to 3 columns) having the elemental iodine displaced. This way, the system may be configured to a size and scale so that the aqueous brine solution always flows at the desired rate as a continuous process. Similarly, the system may be configured to always produce an elemental iodine output.

In some embodiments, the method may further comprise reacting the high concentration elemental iodine with chlorine gas to form iodine monochloride. For example, the concentrated element iodine product may react with an equimolar amount of chlorine gas to form liquid iodine monochloride. The liquid iodine monochloride is collected and may then be used to synthesize iodo-organic compounds such as pharmaceutical and radiological contrasting agents.

Some embodiments may provide a closed loop iodine recovery system that uses regenerable non-ionic adsorption media and environmentally benign non-polar displacement fluids to extract elemental iodine from aqueous brine solutions with minimal emissions and high resource efficiency. Elemental iodine formed in the aqueous brine solution is selectively captured by the non-ionic adsorption media selected for strong affinity elemental iodine and full reversibility with a selected non-polar displacement fluid. Once the non-ionic adsorption media reaches full loading, a non-polar displacement fluid, such as diethyl ether or methyl acetate, is passed through the bed to desorb the elemental iodine and restore the non-ionic adsorption media to its original adsorption capacity. The elemental iodine laden non-polar displacement fluid may be distilled to enable complete solvent recovery, and the resulting wet iodine crystals may be collected and desiccated to produce purified solid elemental iodine. The closed loop regeneration of the non-ionic adsorption media, combined with recycling of the non-polar displacement fluid and the ability to reuse process water, creates an environmentally friendly iodine recovery method that reduces chemical consumption, eliminates air emissions, and minimizes waste generation while enabling stable, repeatable iodine production.

### Example 1

A synthetic brine was prepared based on a known water analysis to evaluate iodine oxidation and adsorption behavior. Five gallons of brine were formulated to match the ionic composition shown in Table 1, including 200 mg/L iodide. The pH was adjusted to approximately 3 using hydrochloric acid, and a slight molar excess of hydrogen peroxide was added as the oxidizing agent. The brine immediately developed a dark orange-yellow coloration, indicating conversion of iodide and other ionic iodine compounds to elemental iodine (I₂).

TABLE 1
Representative Brine Composition

| Ionic | Concentration |
|---|---|
| Species | (mg/L) |
| Na + 1 | 51000 |
| K + 1 | 177 |
| Ca + 2 | 8525 |
| Mg + 2 | 1660 |
| Sr + 2 | 1120 |
| Ba + 2 | 3.44 |
| Cl − 1 | 99122.6 |
| SO4 − 2 | 166 |
| Br − 1 | 767 |
| I − 1 | 200 |

A glass column approximately 3 inches in diameter and 6 inches tall, equipped with a bottom valve and glass frit, was packed with about 6 inches of Osorb™-modified silica adsorbent. The oxidized brine was introduced at a flow rate of roughly 150 mL/min. As iodine was captured, the media turned dark orange while the effluent remained clear, confirming complete adsorption. The colored adsorption front progressed downward until the entire bed was uniformly dark orange, indicating full loading. The column was then rinsed with deionized water and dried with flowing air to remove residual moisture.

Diethyl ether was introduced as the displacement fluid and allowed to flow through the iodine-loaded media. The ether extracted the iodine and exited the column as a dark purple solution, while the media returned to its original pale coloration, indicating complete unloading.

The iodine-containing ether was transferred to a distillation vessel and gently warmed to evaporate the ether. The ether vapor was condensed and collected for reuse. As the ether distilled off, the remaining liquid phase produced a slurry of wet iodine crystals and residual water. The wet iodine crystals were collected and subjected to a desiccation step to remove moisture. The resulting product exhibited >85% recovery yield relative to the iodide originally present in the brine and a purity of approximately 85-92% based on mass balance and visual assessment of crystal quality.

### Example 2

Afield brine sample totaling 100 gallons was obtained from an oil and gas operation. The brine composition corresponded to that shown in Table 2. The brine was first contacted with an oxidizing agent and then passed through a 60 nm ceramic ultrafilter to remove suspended solids. Following filtration, the pH was adjusted to approximately 2.5 using hydrochloric acid. Hydrogen peroxide was added at approximately twice the molar amount required to oxidize the iodide that was present. The brine developed a dark orange-yellow color, indicating conversion of iodide and other ionic iodine compounds to elemental iodine (I₂).

TABLE 2

| Solution Label | OK Raw |
|---|---|
| Al Average ppm | 1.22 |
| B Average ppm | 61.92 |
| Ba Average ppm | 11.49 |
| Be Average ppm | 0.08 |
| Ca Average ppm | 7102.99 |
| Co Average ppm | 0.17 |
| Cr Average ppm | 0.18 |
| Cu Average ppm | 0.22 |
| Fe Average ppm | 4.04 |
| K Average ppm | 681.44 |
| Li Average ppm | 12.06 |
| Mg Average ppm | 1166.55 |
| Mn Average ppm | 1.53 |
| Na Average ppm | 42237.08 |
| P (213.618 nm) ppm | 1.34 |
| P Average ppm | 1.58 |
| Pb Average ppm | 0 |
| Sr Average ppm | 346.45 |
| Zn Average ppm | 0.16 |
| Cl⁻ ppm | 71880 |
| SO₄²⁻ ppm | 545 |
| I⁻ ppm | 210 |

A glass column of the same dimensions described in Example 1 was packed with approximately 10 inches of Sepabeads™ 207 adsorbent. The oxidized brine was introduced at a flow rate of about 500 mL/min. As iodine was adsorbed, the media turned dark orange while the column effluent remained clear, confirming complete iodine capture. The adsorption front progressed downward until the entire bed was uniformly colored, indicating full loading. The media was then rinsed with deionized water and dried with flowing air to remove residual moisture.

Approximately two bed volumes of methyl acetate were introduced as the displacement fluid. The methyl acetate extracted the iodine, exiting the column as a dark purple solution, while the media returned to its original white-brown color, confirming complete unloading of iodine from the Sepabeads™ adsorbent.

The iodine-containing methyl acetate was transferred to a distillation vessel. The solvent was distilled off under gentle heating, and 100% of the methyl acetate was recovered as condensed vapor and returned to the solvent-recovery system. As the solvent was removed, the remaining liquid phase produced a mixture of wet iodine crystals and water. The wet iodine crystals were collected and subjected to a desiccation step to remove residual moisture. The resulting product exhibited greater than 85% recovery yield relative to the iodide originally present in the brine and a purity of approximately 85-92%, consistent with the expected performance of the displacement-and-recovery process.

### Adsorption Media Descriptions

### Osorb

ProSep's Osorb® media is an organically modified silica sorbent engineered through a controlled sol-gel polymerization process that incorporates covalently bound organosilane groups into a highly crosslinked silica network. The resulting material forms a rigid yet elastically responsive porous matrix that exhibits pronounced hydrophobicity and a unique swelling behavior upon exposure to hydrocarbons and other non-polar organic contaminants. Unlike conventional silica gels, the organosilane-modified framework contains flexible, hydrophobic domains capable of absorbing free, dispersed, and dissolved organic species through a combination of partitioning, absorption, and physical entrapment within the expanding pore structure. This swelling-activated uptake mechanism enables high sorptive capacity for a broad range of hydrocarbons, aromatics, and hydrophobic organics while maintaining structural integrity under repeated loading and regeneration cycles. The media can be regenerated through thermal or solvent-based desorption, allowing reversible contraction of the polymerized silica network and restoration of adsorption capacity. Osorb® therefore represents a hybrid inorganic-organic sorbent with tunable hydrophobicity, high affinity for non-polar contaminants, and mechanical robustness suitable for water treatment, polishing, and hydrocarbon recovery applications.

ProSep's Osorb® media differs substantially from both brominated aromatic resins and unfunctionalized styrenic PS-DVB resins in terms of raw-material cost, manufacturing complexity, and operational durability. Osorb is produced from high-purity silica precursors and specialty organosilane reagents that require controlled sol-gel polymerization, solvent exchange, and post-synthetic modification to generate its swelling, hydrophobic, organically modified silica network. These organosilane feedstocks are significantly more expensive than the commodity monomers used in styrenic resins, and the multi-stage synthesis increases production cost and limits scalability. In contrast, unfunctionalized styrenic PS-DVB resins are manufactured from low-cost petrochemical monomers (styrene and divinylbenzene) using mature suspension-polymerization processes that are inexpensive, high-throughput, and widely optimized. Brominated aromatic resins occupy an intermediate position: they begin with the same low-cost PS-DVB backbone but undergo post-polymerization halogenation or co-polymerization with brominated monomers, increasing cost relative to unfunctionalized resins but remaining far less expensive than organosilane-based Osorb.

Operationally, Osorb's hybrid inorganic-organic structure introduces limitations not observed in styrenic resins. The swelling mechanism that enables high sorptive capacity is sensitive to suspended solids, fine particulates, and inorganic impurities, which can obstruct pore expansion or mechanically degrade the matrix over repeated cycles. Styrenic resins—both brominated and unfunctionalized—are mechanically robust, resistant to particulate fouling, and maintain performance across a wide range of water qualities. Chemical durability also diverges sharply: Osorb is susceptible to hydrolysis under low-pH conditions and to oxidative degradation when exposed to hypochlorite, peroxides, or other oxidizing chemistries commonly used in industrial water treatment. Unfunctionalized PS-DVB resins tolerate a broad pH range and moderate oxidizer exposure, while brominated resins exhibit slightly reduced oxidative stability but still outperform Osorb in harsh chemical environments. As a result, Osorb's high raw-material cost, complex manufacturing process, and limited tolerance to impurities and aggressive chemistries restrict its applicability in large-scale, variable-quality, or chemically treated water systems, whereas brominated and unfunctionalized styrenic resins offer lower cost, greater robustness, and broader operational flexibility.

### Polystyrene-Divinylbenzene (PS-DVB)

Polystyrene-divinylbenzene (PS-DVB) resins are highly crosslinked, macroreticular polymeric materials synthesized through suspension polymerization of styrene and divinylbenzene monomers in the presence of porogens that template a permanent pore structure. The polymer backbone consists of aromatic polystyrene chains covalently interconnected by divinylbenzene crosslinks, forming a rigid, three-dimensional network with tunable mechanical strength, porosity, and chemical resistance. The degree of crosslinking-typically ranging from 2% to >20% DVB governs bead rigidity, swelling behavior, solvent compatibility, and thermal stability, with higher DVB content producing more dimensionally stable and chemically robust resins.

During synthesis, the monomer mixture is dispersed as droplets in an aqueous phase containing stabilizers, and polymerization proceeds via free-radical initiation. The inclusion of porogenic solvents (e.g., alkanes, alcohols, or aromatic diluents) induces phase separation during polymerization, generating a macroreticular pore architecture consisting of interconnected macropores and mesopores. This permanent pore network provides high surface area—typically 300 to 900 m²/g depending on formulation—and rapid intraparticle mass transfer, enabling efficient adsorption of hydrophobic organic molecules. The resulting spherical beads exhibit narrow particle-size distributions (commonly 300-1200 m), high crush strength, and low attrition, making them suitable for packed-bed, fluidized-bed, and batch-contacting systems.

PS-DVB resins are inherently hydrophobic due to their aromatic backbone, and adsorption occurs primarily through van der Waals forces, hydrophobic partitioning, and π-π interactions with aromatic solutes. The absence of ionic functional groups in unfunctionalized PS-DVB resins provides broad chemical compatibility, allowing operation across a wide pH range and in the presence of many organic solvents. They exhibit excellent resistance to thermal degradation, moderate oxidizing conditions, and mechanical stress, enabling long service life in industrial water treatment, bioprocessing, chromatography, and solvent recovery applications. Variants of PS-DVB resins may undergo post-polymerization functionalization—such as sulfonation, amination, or halogenation—to introduce ion-exchange or selective adsorption properties, but the unmodified PS-DVB matrix remains the foundational material due to its robustness, low cost, and versatile sorptive characteristics.

### Advantages of Brominated PS-DVB Resins for Iodine Extraction

Brominated aromatic resins provide distinct performance advantages over unfunctionalized polystyrene-divinylbenzene (PS-DVB) resins for the extraction of elemental iodine and polyiodide species due to the enhanced polarizability and modified electronic structure imparted by bromine substituents on the aromatic backbone. The presence of bromine increases the local electron-cloud deformability of the resin surface, strengthening London dispersion forces and halogen-halogen interactions that dominate iodine sorption. These heavy-atom effects also promote more favorable charge-transfer and σ-hole interactions with I₂ and I₃⁻ species, resulting in higher affinity, improved selectivity, and greater sorptive capacity relative to unfunctionalized PS-DVB, which relies solely on weaker hydrophobic and π-π interactions. Bromination further increases resin hydrophobicity, enhancing partitioning of iodine from aqueous or brine environments and reducing competitive displacement by water or polar solutes. Collectively, the increased polarizability, stronger non-covalent interactions, and improved stabilization of molecular and polyiodide iodine species enable brominated resins to achieve higher loading, faster uptake kinetics, and superior extraction efficiency compared to conventional PS-DVB materials.

### Commercially Available PS DVB'S

Polystyrene-divinylbenzene (PS-DVB) resins are commercially manufactured by multiple global suppliers using suspension-polymerization processes that yield highly crosslinked, macroreticular bead materials with controlled porosity, surface area, and mechanical strength. DuPont produces the AmberLite™ XAD™ series—including XAD-2, XAD-4, XAD-7HP, XAD-16, XAD-1180N, and XAD-1600—which exhibit surface areas of approximately 300-900 m²/g, pore volumes of 0.5-1.0 mL/g, and bead sizes between 300 and 1200 μm. Purolite manufactures comparable PS-DVB adsorbents under product numbers such as Purolite® MN102, MN202, MN250, and MN270, which are high-surface-area (600-900 m²/g), macroreticular resins designed for hydrophobic organic removal, solvent extraction, and chromatographic separations. Mitsubishi Chemical supplies two major PS-DVB product families: the Diaion™ series—including HP20, HP21, HP2MG, SP207, and SP850—featuring tailored crosslink densities, pore diameters in the 200-300 Å range, and surface areas up to 700 m²/g for bioprocessing and industrial separations; and the Sepabeads™ series—including SP70, SP700, SP825, and SP850—which are engineered for high-capacity adsorption, natural-product isolation, and pharmaceutical purification, with controlled macroreticular pore structures and DVB crosslinking optimized for solvent compatibility and mechanical durability. Additional suppliers—including Lanxess (Lewatit® VP OC 1065 and S-series PS-DVB resins), Thermax (Tulsion® A-72 and A-860), ResinTech (SIR-1200 and SIR-2000 series), Sunresin (D101, D301, and LX series), and Bio-Rad (Bio-Beads SM-2 and SM-4)—produce PS-DVB beads with defined DVB percentages, pore volumes, and particle-size distributions. Across these product lines, PS-DVB resins share a common aromatic polymer backbone, high mechanical robustness, broad solvent and pH compatibility, and low raw-material cost due to reliance on commodity petrochemical monomers, making them a widely available and economically scalable platform for hydrophobic adsorption, ion-exchange functionalization, and specialty separation media.

### Advantages of Brominating PS DVP Resins

Brominated aromatic polymer resins, including brominated polystyrene-divinylbenzene matrices, exhibit enhanced adsorption performance resulting from systematic modifications to their electronic, steric, and surface-interaction characteristics introduced by bromine substitution.

Incorporation of bromine atoms onto aromatic rings increases molecular polarizability and hydrophobicity, thereby strengthening dispersion interactions and partitioning behavior with hydrophobic and aromatic solutes. These effects provide increased affinity, selectivity, and capacity for large, non-polar, aromatic, polyaromatic, and halogenated compounds, including polycyclic aromatic hydrocarbons, halogenated solvents, dioxins, endocrine-active compounds, pharmaceutical residues, and other high-molecular-weight organic species. Bromination further alters the π-electron system of the aromatic framework, enabling stronger π-π and induced-dipole interactions with conjugated and heteroaromatic molecules, resulting in improved separation of structurally similar compounds and enhanced performance under mass-transfer-limited or trace-level conditions. The increased hydrophobic character of the brominated resin yields higher distribution coefficients and improved loading capacity, particularly in high-salinity or high-total-dissolved-solids aqueous environments and in complex matrices containing competing organic species, cosolvents, surfactants, or emulsified phases. In addition, brominated aromatic resins demonstrate increased selectivity for halogenated organics through like-interacts-with-like interactions and may serve as chemically versatile intermediates for further functionalization, including attachment of ligands, ion-exchange groups, or metal-binding functionalities. The presence of bromine also increases resin density and can enhance mechanical robustness and resistance to attrition, thereby improving suitability for high-velocity or industrial column operations. Collectively, these properties enable brominated aromatic resins to provide superior adsorption efficiency, selectivity, and operational stability relative to non-brominated polymeric sorbents, particularly for challenging organic separations and contaminant removal applications.

### Commercially Available Resins

Brominated polystyrene-divinylbenzene (PS-DVB) resins are supplied by a limited group of specialty polymer manufacturers that produce halogenated aromatic adsorbents with enhanced polarizability and affinity for heavy hydrophobic and halogenated contaminants. Purolite manufactures several brominated PS-DVB materials, including Purolite® Macronet™ MN202B and MN250B, which are produced through controlled electrophilic bromination of macroreticular PS-DVB beads to achieve bromine loadings typically in the 5-15 weight percent (wt %) range, surface areas of 600-900 m²/g, and pore volumes of 0.5-0.9 mL/g. Mitsubishi Chemical supplies brominated variants within its Diaion™ and Sepabeads™ product families, including Diaion™ SP207 and Sepabeads™ SP825L, which incorporate aromatic bromination into a PS-DVB matrix with crosslink densities of 8-20% DVB, average pore diameters of 200-300 Å, and surface areas up to 700 m²/g to improve adsorption of polyaromatic hydrocarbons, halogenated organics, and iodine species. Additional brominated PS-DVB resins are produced by niche specialty polymer manufacturers in the United States, Europe, and Asia that perform custom halogenation of standard PS-DVB matrices to specified bromine contents, bead sizes (typically 300-1200 μm), and macroreticular pore structures for use in analytical cleanup, industrial separations, and environmental remediation. Across these suppliers, brominated PS-DVB resins retain the mechanical robustness and solvent compatibility of conventional PS-DVB materials while exhibiting significantly higher surface polarizability, stronger dispersion interactions, and improved selectivity for iodine, polyiodides, and other highly polarizable organic contaminants.

### Commercial PS-DVB Dupont

Hydrophobic XAD resins from DuPont (formerly Rohm & Haas) are non-ionic, macroporous polymeric adsorbents widely used for the removal, concentration, and purification of hydrophobic and moderately polar organic compounds from aqueous or mixed-phase systems. These resins are commonly applied in bioprocessing, pharmaceutical purification, wastewater treatment, food processing, and environmental remediation. Although the XAD family includes several resin chemistries, the hydrophobic grades-such as XAD-2, XAD-4, XAD-16, XAD-16N, and XAD-16HP N-share a common design philosophy based on crosslinked aromatic polymer matrices with high surface area, controlled pore architecture, and strong affinity for non-polar organic compounds. Among these, XAD-16 and XAD-16HP N are the most thoroughly documented and serve as representative hydrophobic XAD resins.

These hydrophobic XAD resins are constructed from crosslinked polystyrene-divinylbenzene networks. The polymer backbone consists of aromatic polystyrene, with divinylbenzene acting as the crosslinker, and no ionic functional groups are present. As a result, the resin surface is strongly hydrophobic due to the abundance of aromatic rings. This chemistry provides high affinity for hydrophobic organic molecules through van der Waals forces and π-π interactions, along with excellent thermal and chemical stability, resistance to swelling in aqueous and organic media, and mechanical robustness suitable for repeated regeneration cycles.

Structurally, hydrophobic XAD resins are macroreticular, meaning they contain a permanent pore network formed during polymerization. For resins such as XAD-16 and XAD-16HP N, typical properties include a surface area of approximately 800 m²/g, a total pore volume of about 0.6 mL/mL, and a mixed macro- and mesoporous structure that enables rapid mass transfer. This pore architecture supports high adsorption capacity for dissolved organic compounds, fast adsorption kinetics, and suitability for both column and batch operations.

In terms of physical properties, XAD-16HP N is supplied as white, opaque spherical beads with a typical particle diameter of 600 to 750 micrometers. The particle density ranges from approximately 1.015 to 1.025 g/mL, with a shipping weight of about 675 g/L and water retention of 60 to 70 percent as shipped. These characteristics contribute to low pressure drop in packed beds, good hydraulic stability, and predictable backwash expansion behavior, typically around 70 percent expansion at a superficial velocity of 1 m/h at 15° C.

Adsorption on hydrophobic XAD resins occurs primarily through hydrophobic interactions between the aromatic polymer surface and non-polar solutes in water. Van der Waals dispersion forces dominate the adsorption of neutral organic compounds, while π-π interactions enhance affinity for aromatic solutes such as phenols, polycyclic aromatic hydrocarbons, steroids, and related molecules. These mechanisms make hydrophobic XAD resins well suited for extracting water-soluble organic compounds, concentrating trace organics, and purifying a wide range of biomolecules including antibiotics, vitamins, steroids, peptides, and enzymes.

Hydrophobic XAD resins exhibit strong chemical and thermal stability, with maximum operating temperatures up to approximately 150° C. They are resistant to dilute acids and bases and are compatible with water-miscible organic solvents such as methanol, ethanol, acetone, and isopropanol. These properties allow the resins to tolerate steam sanitization, solvent regeneration, and repeated adsorption-desorption cycles without significant degradation.

Regeneration procedures depend on the nature of the adsorbed compounds. Hydrophobic organic compounds are typically desorbed using organic solvents such as methanol, ethanol, isopropanol, or acetone. Weakly acidic species may be removed using dilute sodium hydroxide solutions, while weak bases are regenerated using dilute hydrochloric acid. Volatile compounds can often be removed with hot water or steam. A typical regeneration sequence involves displacement of the feed with water, flushing with the appropriate solvent or dilute acid or base, followed by thorough rinsing with at least twenty bed volumes of water.

From a hydraulic standpoint, hydrophobic XAD resins are commonly operated at loading flow rates between 2 and 16 bed volumes per hour, with elution typically conducted at approximately 2 bed volumes per hour. Backwash expansion is predictable and allows reliable design of packed-bed adsorbers, lead-lag polishing systems, and continuous or batch purification processes.

### Commercially Available Adsorption Media Products

DuPont—AmberLite™/XAD™ Series (PS-DVB)
XAD-2; XAD-4; XAD-7HP; XAD-16; XAD-1180N; and XAD-1600.
Purolite—PS-DVB and Brominated PS-DVB, Unfunctionalized/Macroreticular PS-DVB
Purolite® MN102; Purolite® MN202; Purolite® MN250; and Purolite® MN270. Brominated PS-DVB
Purolite® Macronet™ MN202B; and Purolite® Macronet™ MN250B.
Mitsubishi Chemical—Diaion™ Series (PS-DVB)
Diaion™ HP20; Diaion™ HP21; Diaion™ HP2MG; Diaion™ SP207; and Diaion™ SP850.
Mitsubishi Chemical—Sepabeads™ Series (PS-DVB)
Sepabeads™ SP70; Sepabeads™ SP700; Sepabeads™ SP825; Sepabeads™ SP825L; and Sepabeads™ SP850.
Lanxess—Lewatit® Series (PS-DVB)
Lewatit® VP OC 1065; and Lewatit® S-Series (e.g., S 100 family).
Thermax—Tulsion® Series (PS-DVB)
Tulsion® A-72; and Tulsion® A-860
ResinTech—SIR Series (PS-DVB)
ResinTech® SIR-1200; and ResinTech® SIR-2000.
Sunresin—Adsorbent Series (PS-DVB)
Sunresin® D101; Sunresin® D301; and Sunresin® LX Series.
Bio-Rad—Bio-Beads (PS-DVB)
Bio-Beads SM-2; and Bio-Beads SM-4.

FIG. 1 is a diagram of a system for processing an aqueous brine solution that contains ionic iodine compounds and for collecting a concentrated elemental iodine product according to some embodiments. A source of incoming raw aqueous brine solution 10, such as a geological brine, may be a tank or stream. Without limitation, the incoming raw brine may be obtained from a producing oil and gas well, geothermal well, and/or saltwater disposal (SWD) gathering pipeline. It could also be from any industrial process such as seaweed refining, desalination or other waste streams that contain appropriate levels of ionic iodine compounds such as iodide, iodate and/or iodite slats. The brine may also come from an evaporation unit, reverse osmosis (RO) system or blowout tower used to make an initial increase the concentration of the ionic iodine compounds. Furthermore, the brine may also be a recycled waste breakdown product where the ionic iodine compounds have been dissolved in water. Optionally, the brine may be treated to remove any hydrocarbons that may be present in the brine before providing the brine as input to the system. In an oilfield operation, the brine may be passed through a separator, heater treater, hydro cyclone, gun barrel, diffuse air flotation (DAF) and/or other brine treatment system.

Ionic iodine compounds suitable for recovery by the present invention may be found in a wide range of aqueous streams originating from geological, industrial, biological, and anthropogenic processes. Geological sources of ionic iodine compounds include deep subsurface brines associated with ancient marine sediments, organic-rich shales, and evaporitic formations. These brines accumulate iodine through long-term diagenetic degradation of marine biomass and halogen mobilization from kerogen, resulting in iodide concentrations that may exceed several hundred milligrams per liter. Such geological brines are encountered in sedimentary basins, geothermal reservoirs, and hydrocarbon-bearing formations, and represent some of the highest natural concentrations of dissolved iodine available for extraction.

Significant volumes of aqueous brine solutions may also be generated as produced water during oil and gas production. Produced water may contain formation brine, injected fluids, dissolved salts, hydrocarbons, and naturally occurring ionic iodine compounds mobilized from the reservoir. In many basins, produced water contains iodide concentrations far exceeding those of seawater. These waters are frequently transported to saltwater disposal (SWD) facilities, where they are aggregated and injected into disposal formations. saltwater disposal facilities therefore provide centralized, continuous, and high-volume streams containing ionic iodine compounds that are well-suited for large-scale recovery.

Additional aqueous brine solutions arise from mining operations, particularly nitrate, caliche, and potash mining, where iodate and iodide are mobilized during ore leaching and beneficiation. Industrial processes also generate wastewaters containing ionic iodine compounds, including halogenated-compound synthesis, disinfectant manufacturing, pulp and paper bleaching, pharmaceutical production, and specialty chemical operations. These industrial effluents may contain ionic iodine compounds in multiple oxidation states, including iodide, iodate, molecular iodine, and organically bound iodine species.

Ionic iodine compounds are also present in desalination concentrate streams, especially those produced by seawater reverse osmosis (SWRO) and brackish-water desalination systems. As water is removed during desalination, ionic iodine compounds becomes enriched in the reject brine, creating a concentrated source of ionic iodine compounds that is typically discharged without recovery. Additional industrial wastewaters, including those from food processing, fermentation, and cleaning operations, may contain ionic iodine compounds that are currently treated as waste despite their recoverable value.

Biological and biomass-derived sources contribute further aqueous streams containing ionic iodine compounds. Seaweed and kelp processing, including extraction of alginates, carrageenan, and marine biopolymers, generates wash waters and process liquors containing iodide and organically bound iodine. These streams often contain ionic iodine compounds in concentrations significantly higher than seawater and represent a renewable iodine source. A growing anthropogenic source of ionic iodine compounds is wastewater containing iodinated X-ray contrast agents, which are excreted largely unmetabolized and pass through municipal wastewater treatment systems. These persistent organo-iodine compounds accumulate in effluent and sludge streams, creating a new category of iodine-rich wastewater suitable for recovery and recycling.

Pretreatment operations or systems 20 may include filtering, adjusting the pH and adding an oxidizer to the aqueous brine solution. These pretreatment steps may be performed in various orders, but one preferred order includes adjusting the pH, filtering and then adding the oxidizer.

In some embodiments, the pH of the incoming brine may be adjusted to be greater than 5.5. More preferably, the pH may be adjusted to be greater than 6.5. The pH of the incoming brine may be adjusted (i.e., increased) by adding sodium hydroxide or caustic or other bases, such as calcium oxide, calcium hydroxide, potassium hydroxide or another mineral base.

In some embodiments, an oxidizer may be added in sufficient quantity to ensure that the brine has an oxidation-reduction potential greater than zero. Without limitation, the oxidizer may be bleach, hypochlorous acid, sodium hypochlorite, ozone, peracetic acid, chlorine dioxide and/or hydrogen peroxide. The addition of an oxidizer ensures that any iron within the brine is converted to the plus three (3+) oxidation state Fe(III). In the Fe(III) state, iron will flocculate and can be more easily filtered out of the brine. The process unit where oxidation takes place should have a sufficient residence time for these chemical reactions to take place, such as from 30 seconds to several hours. The addition of oxidizer also ensures that all H₂S and FeS have been eliminated and will facilitate better hydrocarbon separation.

In some embodiments, the filtering of the brine may involve a pretreatment filter that performs microfiltration or ultrafiltration. The pretreatment filter may improve clarity and reduce total petroleum hydrocarbons (TPH) of the brine. In one option, the pretreatment filter may produce a brine with <10 ppm (parts per million) insoluble hydrocarbons, or perhaps even <1 ppm. In one option, the pretreatment filter may include an activated carbon black filter and/or other type of filter designed to adsorb or filter hydrocarbons to a very low concentration. The filtered brine preferably has a level of total suspended solids (TSS) that is <20 ppm or more preferably <1 ppm. The filter media may include socks, sand, walnut shells, and/or polymer fibers. In another option, the filter media may be a ceramic filter membrane, such as a ceramic filter membrane producing a filtrate (i.e., the output through the filter) having a nominal particle size of 200 nm or preferably 60 nanometers. Filtration is used to reduce the total insoluble organics and suspended solids in the brine, which may impact the performance of one or more downstream processes. For example, excess insoluble organics and suspended solids can cause maintenance issues.

In some embodiments, the aqueous brine solution may first undergo gravity separation to remove free oils and buoyant hydrocarbons, followed by induced-gas flotation (IGF) or dissolved-air flotation (DAF) to strip emulsified oils and dispersed hydrocarbons through bubble attachment and surface skimming. Additional oil removal may be achieved using coalescing media, which promote droplet agglomeration, or walnut-shell filtration, which provides deep-bed adsorption and mechanical capture of hydrocarbons under high-salinity conditions. Hydrocyclones may be used to remove fine oil droplets and dense particulate matter through centrifugal separation, while membrane clarification can polish the stream by removing residual emulsions and colloidal material. Suspended solids and iron species may be removed through coagulation and flocculation, which destabilize colloids and form filterable flocs, followed by multimedia filtration or cartridge filtration to capture precipitated iron hydroxides, silt, and organic particulates. In high-salinity brines, pretreatment may also include targeted removal of barium, strontium, and carbonate scale precursors to prevent downstream mineral fouling. After bulk impurity removal, the brine is subjected to microfiltration or ultrafiltration as previously described, where the TPH may be reduced to <1 ppm, the TSS may be reduced to <1 ppm, and the soluble iron may be reduced to <1 ppm. In a preferred embodiment, the brine is passed through a LiqTech ceramic ultrafiltration membrane constructed of sintered silicon carbide with a nominal pore size of approximately 200 nanometers, and more preferably 60 nanometers, to achieve high-efficiency removal of fine particulates, iron floc, organic matter, and residual hydrocarbons. This ceramic ultrafiltration step provides exceptional chemical resistance, mechanical durability, and flux stability in harsh, high-TDS (total dissolved solids) environments. Collectively, these pretreatment operations ensure that the aqueous brine solution entering the extraction system is free of insoluble contaminants, thereby improving the efficiency of capturing elemental iodine, protecting downstream equipment, minimizing maintenance, and enabling stable long-term operation.

Embodiments may, after the pretreatment operations 20, include further operations or systems 30 to chemically convert ionic iodine compounds, such as iodide (I¹⁻) and/or iodate (IO₃¹⁻), in the aqueous brine solution to form elemental iodine (I₂). The process may treat an aqueous brine solution containing ionic iodide compounds by adjusting the pH of the aqueous brine solution by adding an acid and converting iodide within the brine to elemental iodine (I₂) using an oxidizer.

The pH in the aqueous brine solution may be controlled or adjusted to increase the yield of elemental iodine (I₂). The pH may, for example, be adjusted in a water holding tank, reactor or pipe with a static mixer. The pH of the aqueous bring solution may be adjusted to within a range from about 0 to about 5.5. In specific embodiments, the pH of the brine may be adjusted to within a range from about 0 to about 4.5. In further embodiments, the pH of the brine may be controlled in a range from about 1.0 to about 2.5. The pH of the brine may be controlled or adjusted by adding any common acid or mineral acid, such as hydrochloric acid or sulfuric acid.

The oxidizer used to convert the ionic iodine compounds in the aqueous brine solution to form elemental iodine (I₂) may be, for example, hypochlorous acid, sodium hypochlorite and/or hydrogen peroxide. The oxidizer will typically be added in molar excess to the amount of ionic iodine compounds present in the brine. The exact amount of oxidizer added to the brine may be based on, or optimized for, complete conversion to elemental iodine (I₂) considering reaction kinetics and the concentration of iodide in the brine. Although an excess amount of oxidizer may be added to ensure full oxidation of the iodide and/or iodate to elemental iodine (I₂), the amount of oxidizer may be optimized to achieve the oxidation while also preventing overoxidation of the elemental iodine (I₂) to iodate (IO₃¹⁻)

In one option, hydrogen peroxide or other oxidizer may be added into the aqueous brine solution at an appropriate rate or amount, such as a rate or amount determined to oxidize the ionic iodine compounds in the aqueous brine solution to elemental iodine (I₂) while also preventing overoxidation of the elemental iodine (I₂) to iodate (IO₃¹⁻). Without limitation, the source of hydrogen peroxide (an oxidizer) may have a concentration of about 15-34% hydrogen peroxide by mass in water. In another option, sodium hypochlorite (an oxidizer) may be provided at a very high pH and a 12.5% concentration. In a further option, the hypochlorous acid or sodium hypochlorite (oxidizers) may be generated electrolytically from an aqueous solution containing iodide or in a separate electrolytic cell using a salt solution. Electrolytically generating hypochlorite or hypochlorous acid on site may reduce shipping expenses and may be more environmentally friendly.

In some embodiments, the iodide in the aqueous bring solution may be directly converted to elemental iodine (I₂) in an electrolytic process. For example, the aqueous brine solution containing the iodide and/or other ionic iodine compounds may be directed to flow across electrodes having sufficient oxidative potential to convert the iodide and/or other ionic iodine compounds to elemental iodine (I₂).

In some embodiments, the conversion of iodide to molecular iodine is carried out under controlled acidic and oxidative conditions to ensure that more than 90%, and preferably more than 95-99%, of the dissolved ionic iodide is transformed into elemental iodine (I₁). Elemental iodine (I₂) is the only iodine species that exhibits strong hydrophobicity and therefore high affinity for the downstream non-polar adsorption media. Under acidic conditions, iodide is oxidized to iodine through reactions such as:

$$HOCl + 2 {I}^{-} + {H}^{+} \to {I}_{2} + {Cl}^{-} + {H}_{2} O \qquad Eq . 1$$

$${H}_{2} {O}_{2} + 2 {I}^{-} + 2 {H}^{+} \to {I}_{2} + 2 {H}_{2} O \qquad Eq . 2$$

These reactions are strongly favored at low pH, where the oxidizing strength of oxidizer (such as hypochlorous acid and/or hydrogen peroxide) is maximized and the equilibrium between I⁻, I₂, and IO₃⁻ shifts toward elemental iodine (I₂). Maintaining the brine at a pH between 1.0 and 5.5, preferably between 1.0 and 4.5, and in further embodiments between 1.0 and 2.5, suppresses the formation of hypochlorite ion (OCl⁻), which is the species primarily responsible for aggressive over-oxidation. Over-oxidation of elemental iodine (I₂) to iodate proceeds through pathways such as:

$${I}_{2} + 5 HOCl + 2 {H}_{2} O \to 2 I {O}_{{3}^{-}} + 5 {Cl}^{-} + 6 {H}^{+} \qquad Eq . 3$$

Formation of iodate according to Eq. 3 is undesirable because iodate is non-hydrophobic, non-volatile, and cannot be captured by the hydrophobic non-polar adsorption media, resulting in permanent loss of recoverable ionic iodine compounds. Low pH suppresses Equation 3 by stabilizing I₂ relative to IO₃⁻, increasing the redox potential required for iodate formation, and minimizing disproportionation reactions that would otherwise convert I₂ to IO₃⁻. This thermodynamic condition exists for peroxide oxidation also. The oxidizer may be added in controlled molar excess relative to the iodide concentration, with the dosage optimized to ensure complete conversion according to Equations 1-2 while avoiding the oxidative conditions that promote Equation 3. Reaction conditions such as oxidant concentration, residence time, mixing intensity, and temperature may be controlled to ensure that iodide is fully converted to I₂ without prolonged exposure to high oxidative potentials. Achieving near-quantitative conversion is essential because unreacted ionic iodine compounds will remain in the aqueous phase and bypass the non-polar adsorption media, while iodate formed via Equation 3 is non-adsorbable. By maintaining low pH, controlled oxidant dosing, and sufficient residence time, the process ensures that elemental iodine (I₂) is the predominant iodine-containing compound in the aqueous brine solution, enabling efficient adsorption, maximizing recovery yield, and ensuring stable long-term operation of the iodine-capture system.

In some embodiments, electrolytic production of oxidizing agents provides a controlled, on-site method for generating the oxidative species required to convert ionic iodine compounds to elemental iodine (I₂). The electrolytic processes may include two primary configurations: (1) electrolytic generation of hypochlorous acid or hypochlorite from a purified salt solution, and (2) direct electrochemical oxidation of halides or iodide within the brine itself. In the first configuration, a purified sodium chloride solution is passed through an electrolytic cell where chloride ions are oxidized at the anode to chlorine gas, which hydrolyzes to form hypochlorous acid according to the reactions:

$$2 {Cl}^{-} \to {Cl}_{2} + 2 {e}^{-}$$

$${Cl}_{2} + {H}_{2} O \to HOCl + {H}^{+} + {Cl}^{-}$$

The resulting hypochlorous acid or hypochlorite solution is produced at controlled concentration and pH, eliminating the need to transport commercial bleach, which is typically stabilized at high pH and can disrupt the acidic conditions required for selective conversion of ionic iodine compounds to elemental iodine (I₂). On-site electrolytic generation of the oxidizer also avoids degradation of stored hypochlorite, reduces chemical handling risks, and lowers operating cost by producing only the amount of oxidizer required for real-time process demand.

In the second configuration, the oxidizing species may be electrolytically generated directly within the aqueous brine solution, allowing the brine itself to serve as the electrolyte. When chloride is present, anodic oxidation produces hypochlorous acid in situ through the same reactions described above, enabling direct formation of the oxidizer without intermediate storage or dilution steps. When iodide is present at sufficient concentration, the electrode potential can be controlled to oxidize iodide directly to molecular iodine according to:

$$2 {I}^{-} \to {I}_{2} + 2 {e}^{-}$$

This direct electrochemical oxidation eliminates the need for chemical oxidizers entirely and provides precise control over the oxidative environment, allowing the system to maintain the redox potential required to convert iodide to iodine while suppressing over-oxidation to iodate. Because no high-pH bleach is introduced, the aqueous brine solution does not experience alkaline pH shocks, reducing scaling tendencies and maintaining the low-pH conditions needed for selective iodine formation. Both electrolytic approaches reduce shipping and storage of hazardous oxidizers, minimize environmental impact, and provide a highly controllable, energy-efficient method for generating the active oxidizing species required for high-yield recovery of elemental iodine (I₁).

The oxidation of the ionic iodine compounds to element iodine (I₂) was further evaluated and optimized using thermodynamic solution modeling to determine the ideal combination of oxidizer dosage and pH for maximizing conversion of iodide to elemental iodine while suppressing over-oxidation to iodate. This modeling and analysis was performed using OLI Studio 12.5, which provides an electrolyte-based thermodynamic framework capable of predicting speciation, redox equilibria, and phase behavior in complex brine systems. The model was constructed using a measured brine composition and evaluated across a range of pH values and oxidizer concentrations representative of process conditions.

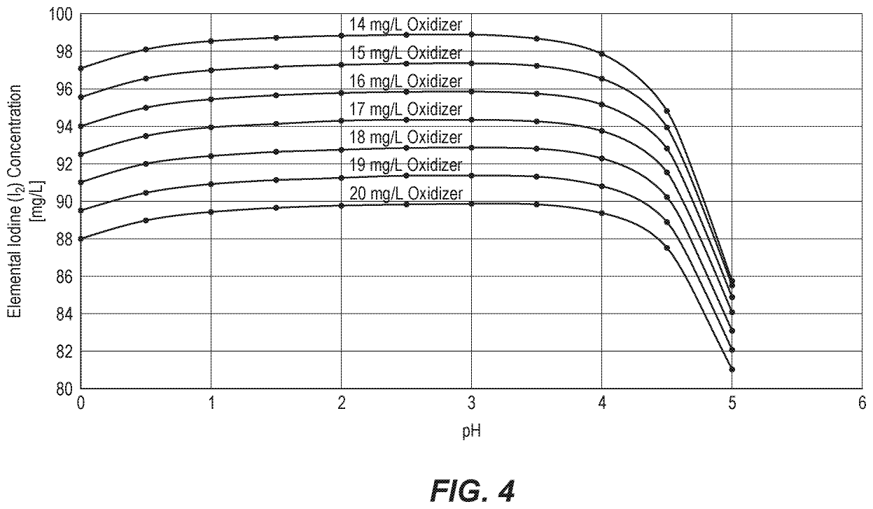

FIG. 4 is a graph illustrating the yield of elemental iodine (I₂) as a function of the pH of the aqueous brine solution for seven different oxidizer concentrations ranging from 14 to 20 mg/L produced by the modeling software. The equilibrium speciation profiles illustrate the relative stability regions of elemental iodine (I₂) (and also iodide and iodate) as a function of pH and oxidizing strength. FIG. 4 illustrates that elemental iodine (I₂) formation is strongly favored in the mildly acidic region (see the plateau at pH levels between 2 and 4), with optimal conversion occurring when the oxidizer level is sufficient to shift the redox potential into the iodine-stability window without exceeding the threshold at which iodate becomes thermodynamically preferred. The modeling results confirm that maintaining the brine within the targeted acidic pH range and controlling oxidizer addition within the optimized band produces near-quantitative conversion of ionic iodine compounds (such as iodide) to element iodine (I₂) while minimizing the formation of non-recoverable iodate. These findings support the process design and provide a predictive basis for selecting operating conditions that maximize elemental iodine yield and process efficiency.

Embodiments may, after forming elemental iodine (I₂) in the aqueous brine solution in operations 30, include further operations or systems 40 for adsorbing the elemental iodine (I₂) out of the aqueous brine solution. Specifically, elemental iodine (I₂) (the sorbate) that is dissolved in an aqueous brine solution may be adsorbed on a solid non-polar adsorption material or media (the sorbent). The non-polar adsorption material or media may be contained in an adsorption unit or subsystem (adsorption media chamber, vessel or column). Ideally, the non-polar adsorption media may be robust or durable so that the adsorption material can be regenerated within the adsorption unit and used many times.

In some embodiments, the non-polar adsorption material may be a swellable hydrophobic material that has been designed specifically for sorbing or extracting a non-polar compound from an aqueous stream. A non-polar compound has an even distribution of charge due to equal electron sharing. All non-polar compounds are nonionic (covalent). In some embodiments, the non-polar adsorption media includes a polymeric material such as a butadiene, epoxy, poly urea, polyurethane or styrene backbone functionalized with aromatic or aryl groups. The polymer backbone or base particle composition provides rigidity, thermal stability, and a tunable pore structure, while the organic functionalization imparts swelling behavior and affinity for non-polar components. The aromatic groups may be further modified with bromine or iodine. Alternatively, any of the non-polar adsorption media described in this disclosure may be utilized.

In some embodiments, the non-polar adsorption media may include a substrate having aromatic functional groups, such as a substrate made with styrene divinylbenzene. The aromatic groups of the styrene divinylbenzene may be functionalized with bromine. Optionally, the styrene divinylbenzene substrate may have a pore size of about 50 to 500 angstroms and/or a specific surface area that is greater than about 300 square meters per gram (m²/g) and more preferably greater than about 500 (m²/g). In a further option, the non-polar adsorption material may be formed as spherical particles and may have a consistent or variable particle size. In one example, the non-polar adsorption media may be Sepabeads SP207 (available from Mitsubishi Chemical), which is a brominated styrene-divinylbenzene (PS-DVB) polymer resin. Sepabeads SP207 is a nonionic, highly porous synthetic adsorbent with a brominated aromatic ring, which increases its hydrophobicity and selectivity for hydrophobic compounds.

In some embodiments, the non-polar adsorption media may be Dianion HP20 and SP70 and SP700. The non-polar adsorption material or media may also be obtained from other suppliers, such as Dupont AmberChrom products, Sunresin Seplite LXA207, and/or Ecolab's Puralite product line. The non-polar adsorption media is hydrophobic, aromatically functionalized and designed to adsorb nonpolar substituents from aqueous streams. The non-polar adsorption media may also have a selectivity to extract non-polar compounds from aqueous streams. The functional groups that modify the surface can be siloxyalkanes, siloxyaromatic compounds, alkyl, aryl or functionalize aryl groups, such as brominated aryl groups.

In some embodiments, the non-polar adsorption material or media may be a silica substrate that has been modified with a hydrocarbon. The non-polar adsorption material or media preferably forms particles having a high-surface area per unit of volume.

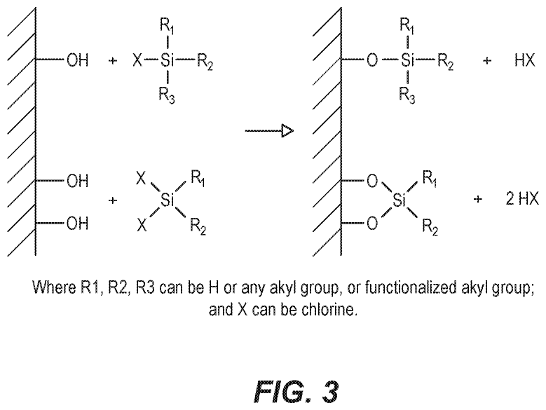

In some embodiments, the non-polar adsorption material or media may be a polymeric or gelled material, such as an organosilicon polymer or a pure organic polymer. The polymeric or gelled material may have a high porosity and the surface of the material may be functionalized with hydrophobic groups. In some embodiments, the non-polar adsorption material or media includes alkyl siloxy substituents. For example, the alkyl siloxy substituents may be characterized by the formula: —Oₓ—Si—R_{y} where each R is independently a branched, linear or aromatic hydrocarbon containing up to about 30 carbons, x is 1 or 2, y is 2 or 3 and the total of x and y is 4. The formation of two examples of the alkyl siloxy substituents on the surface of a solid media is illustrated in FIG. 3. Osorb™ is an example of an organically modified silica made by ABS Materials (now Aquanex Technologies) and sold by companies such as Prosep.

In some embodiments, an adsorption subsystem may include one or more columns or chambers each containing a quantity of the non-polar adsorption media. In one option, multiple adsorption columns may be provided in parallel, may be connected to the same or independent input sources of brine and may be connected to the same or independent downstream processes. In some implementations, providing multiple parallel adsorption columns or chambers may decrease downtime and/or increase throughput.

An aqueous brine solution containing elemental iodine (I₂) may be introduced into, or passed through, the adsorption subsystem to adsorb the elemental iodine (I₂) from the aqueous brine solution onto the non-polar adsorption media. The aqueous brine solution containing the elemental iodine (I₂) may be run into or through the non-polar adsorption system for any amount of time or until reaching a desired condition but preferably continues until the non-polar adsorption media is saturated or nearly saturated with elemental iodine (I₂). Optionally, the aqueous brine solution containing the elemental iodine (I₂) may be run through the non-polar adsorption system until a concentration of the elemental iodine (I₂) in the aqueous brine solution leaving the adsorption system (i.e., the effluent) increases to a predetermined setpoint indicating that the non-polar adsorption media is saturated or nearly saturated.

Once the aqueous brine solution leaves the adsorption subsystem, the aqueous brine solution (effluent) may be pumped to one or more other processes, such as mineral extraction, desalination, other industrial process, brine sales, recycle in hydraulic fracturing, or discarding in a saltwater disposal well. The brine output from the adsorption subsystem may be very clean and may be suitable for use in reverse osmosis processing to remove ions.

The apparatus (vessel) used to bring the aqueous brine solution containing the elemental iodine into contact with the non-polar adsorption media is designed to maintain controlled hydraulic conditions, uniform flow distribution, and sufficient residence time to enable efficient mass transfer of molecular iodine from the aqueous phase into the media. The system typically consists of one or more packed bed or columnar vessels constructed of corrosion resistant materials capable of operating under high salinity, low pH, and oxidizing conditions. The aqueous brine solution may enter the vessel through an inlet distribution manifold engineered to provide even flow across the entire cross section of the bed, preventing channeling, dead zones, or localized high velocity regions that would reduce contact efficiency. The vessel may incorporate flow straighteners, perforated plates, or diffuser assemblies to ensure uniform hydraulic loading and consistent wetting of the media. The aqueous brine solution then flows (via downflow or upflow) through the bed of non-polar adsorption media depending on the desired hydraulic profile, with downflow operation providing stable packing and upflow operation offering improved tolerance to fine particulate carryover.

The flow rate may be controlled by variable speed pumps, automated valves, and flow meters, allowing the system to maintain a defined empty bed contact time (EBCT) appropriate for the iodine concentration and adsorption kinetics. Pressure sensors and differential pressure monitoring across the vessel may be used to enable detection of fouling, compaction, or flow obstruction, enabling timely backwashing or maintenance. The apparatus may include multiple vessels in parallel to allow continuous operation during media regeneration or replacement, or multiple vessels in series to achieve staged polishing and maximize iodine removal efficiency. Internal support structures such as underdrains, screens, or retaining plates may be implemented to hold the media in place while allowing uniform effluent flow and preventing media migration.

Temperature, pH, and oxidation reduction potential (ORP) may be monitored at the inlet and outlet to the adsorption unit to ensure that the brine remains within the chemical conditions required for optimal iodine adsorption. The system may also incorporate sampling ports at various heights within the vessel to evaluate iodine breakthrough profiles and verify that the adsorption front is progressing as expected. In some embodiments, the apparatus may include automated control systems that adjust flow, pressure, or vessel sequencing based on real time iodine concentration measurements, ensuring consistent performance across variable brine compositions. Collectively, the apparatus is engineered to maintain stable hydraulic conditions, maximize contact between the brine and the adsorption media, and ensure efficient transfer of molecular iodine into the solid phase for high yield recovery.

The non-polar adsorption media may be a regenerable, hydrophobic sorbent media functionalized with benzyl-based groups that exhibit high affinity for neutral, elemental iodine (I₂) under a wide range of salinities and brine compositions. The non-polar adsorption media may become fully loaded with elemental iodine and may be fully regenerated post displacement to its original adsorption capacity. The hydrophobic non-polar adsorption media used for elemental iodine recovery may be engineered to exploit the fundamental shift in iodine chemistry that occurs when ionic iodine compounds are oxidized to elemental iodine (I₂). The elemental iodine (I₂) is nonionic, non-polar, and highly partitionable into hydrophobic phases, enabling its selective removal from aqueous brine solutions through adsorption, absorption, and/or other physical partitioning mechanisms. Hydrophobic adsorption media are therefore designed with surface chemistries, pore structures, and polymer backbones that preferentially interact with neutral, polarizable molecules such as elemental iodine (I₂) while excluding or minimally interacting with ionic species like iodide or iodate. These non-polar adsorption materials typically possess high internal surface area, controlled porosity, and chemical robustness that allow them to operate effectively in high salinity, low pH, and oxidizing environments. Their hydrophobic domains create a thermodynamically favorable environment for elemental iodine (I₂) uptake, allowing elemental iodine (I₂) to diffuse from the aqueous phase into the solid phase where it is retained through van der Waals forces, halogen bonding, π polarizability interactions, or physical entrapment within the media's pore network. Because the adsorption mechanism depends on the hydrophobicity and neutrality of elemental iodine (I₂), the performance of the non-polar adsorption media is directly tied to the completeness of the conversion of the ionic iodine compounds to elemental iodine (I₂). The hydrophobic non-polar adsorption media thus serves as the core separation technology in the iodine recovery process, providing a stable, regenerable, and high capacity platform for capturing elemental iodine (I₂) from a wide range of aqueous brine solutions. These non-polar adsorption materials form the foundation upon which various specialized commercial materials, each with distinct structural, chemical, and operational characteristics, may be developed and deployed for extraction of elemental iodine (I₂).

The effectiveness of non-polar adsorption media in capturing elemental iodine is governed by the interplay between elemental iodine's intrinsic hydrophobicity (quantified by its n-octanol/water partition coefficient (K_{ow})) and the physical and chemical characteristics of the non-polar adsorption media. The partition coefficient defines the thermodynamic driving force for elemental iodine (I₂) to migrate from the aqueous phase into a hydrophobic solid phase. Elemental iodine's log K_{ow} of 1.8-2.49 indicates a strong preference for hydrophobic environments, and this preference directly governs how readily elemental iodine (I₂) partitions into the non-polar adsorption media. Elemental iodine (I₂) experiences a favorable free energy gradient that drives diffusion into the media's pore network. The pore structure determines the kinetics of this transfer: mesopores facilitate rapid transport of iodine into the interior of the media, while micropores provide high energy adsorption sites that ultimately determine loading capacity. Surface polarity further modulates this behavior by influencing the interfacial energy between the aqueous phase and the solid phase; non-polar or weakly polar surfaces lower the energetic barrier for elemental iodine (I₂) uptake, allowing the thermodynamic preference predicted by Eq. 1 to be fully realized. Conversely, surfaces with excessive polarity or ionic character disrupt this partitioning process by preferentially interacting with water, reducing the effective driving force for elemental iodine (I₂) migration. The combined effect of the K_{ow} of elemental iodine (I₂), the non-polar adsorption media's pore architecture, and the non-polar adsorption media's surface polarity therefore determine both the rate and extent of elemental iodine (I₂) loading, shaping breakthrough behavior, mass transfer efficiency, and overall adsorption performance.

Embodiments may, after the elemental iodine (I₂) has been adsorbed on the non-polar adsorption media in operation 40, include further operations involving a source of clean water 50. Once the non-polar adsorption media has been loaded with elemental iodine (I₂), clean water may be caused to flow through the non-polar adsorption material to remove all ionic and water soluble impurities that remain on the adsorption material.

The elemental iodine (I₂) is hydrophobic and remains on the adsorption material rather than enter into the polar water (a solvent), whereas the water soluble and ionic species on the adsorption material will be removed by the clean water. For example, an amount of clean water equal to about 1 to 5 volumes of the non-polar adsorption media may be caused to flow through the non-polar adsorption media to ensure a high degree of impurity removal. After flowing through the non-polar adsorption media, this water may be treated and reused. In fact, filtration and reverse osmosis (RO) processes could be implemented within the system to produce clean water and thereby eliminate or reduce the net amount of freshwater input into the process and making the system more environmentally friendly.

Embodiments may, after the rinsing the non-polar adsorption media with clean water from source 50 to remove ionic and water soluble impurities from the adsorption material, further include flowing a dry gas from a dry gas source 60 through the non-polar adsorption media to remove excess water. Without limitation, the dry gas can be dry air or nitrogen. The dry gas could be warmed or cooled to dry the elemental iodine (I₂) on the adsorption material while minimizing any loss of elemental iodine (I₂) to vaporization. After removing the excess water or most of the water with the dry gas, the elemental iodine (I₂) remains on the adsorption media and has a high purity.

The clean water rinse followed by the dry gas purge removes water-soluble impurities from an iodine loaded adsorption bed by sequentially displacing, dissolving, and evaporating the aqueous phase that contains dissolved ions and soluble organics. After elemental iodine (I₂) loading is complete, clean water is introduced into the vessel at a controlled flow rate to flush the interstitial liquid from the pore network of the media. This rinse water dissolves and carries away all ionic species remaining in the bed, including chloride (Cl⁻), bromide (Br⁻), iodide (I⁻), iodate (IO₃⁻), sulfate (SO₄²⁻), bisulfate (HSO₄⁻), nitrate (NO₃⁻), carbonate (CO₃²⁻), bicarbonate (HCO₃⁻), and cations such as sodium (Na⁺), potassium (K⁺), calcium (Ca²⁺), magnesium (Mg²⁺), iron (Fe²⁺/Fe³⁺), barium (Ba²⁺), and strontium (Sr²⁺). The rinse also removes water soluble organic compounds that may be present in the brine or introduced during pretreatment, including short chain organic acids, alcohols, aldehydes, ketones, glycols, surfactants, and low molecular weight petroleum derivatives. Because these species remain fully soluble in water and exhibit negligible affinity for hydrophobic media, they are efficiently displaced through convective flow and diffusion driven mass transfer as 1 to 5 bed volumes (i.e., volumes of the adsorption media) of clean water pass through the system.

Once the aqueous phase has been displaced, a stream of dry air or inert gas is introduced to remove the residual moisture that remains trapped within the pore structure or adsorbed as thin films on the surface of the non-polar adsorption media. As the dry gas flows through the bed of non-polar adsorption media, the dry gas physically pushes out entrained water, displacing liquid from void spaces and accelerating drainage. Simultaneously, the low humidity of the gas lowers the local vapor pressure, causing rapid evaporation of the remaining water films, which in turn strips out the last traces of dissolved ionic species and soluble organics. The dry gas may be temperature conditioned, either warmed to increase evaporation rate or cooled to suppress elemental iodine (I₂) vapor pressure, to optimize drying while preventing loss of elemental iodine (I₂). This combined displacement and evaporation mechanism ensures that the elemental iodine (I₂) remaining on the adsorption media is in a dry, high purity state, free of aqueous contaminants and ready for the subsequent desorption or recovery step. This is an advantage over ion exchange and blow down processes, in that the wet elemental iodine (I₂) adsorbed on the media is almost impurity free.

Once the non-polar adsorption media in the adsorption unit 40 is clean and dry, the non-polar adsorption media is exposed to a displacement fluid, also referred to as a desorption fluid, from a displacement fluid source 90. The function of the displacement fluid is to remove the elemental iodine (I₂) from the adsorption media. The displacement fluid will flow through the adsorption media and the elemental iodine (I₂) will dissolve into the displacement fluid (solvent). The displacement fluid must possess a high solubility for the elemental iodine (I₂) or any other targeted organics absorbed on the non-polar adsorption media. Ideally, the displacement fluid will remove all of the elemental iodine (I₂) that is loaded on the non-polar adsorption media by flowing 1-2 bed volumes of the displacement fluid through the adsorption media. Non-limiting examples of a suitable displacement fluid include propane, butane, pentane or hexane, chloroethane, dichloromethane, carbon tetrachloride, ethanol, acetone, dimethyl ether, diethyl ether, methyl-tert-butyl ether, tetrahydrofuran, t-butyl acetate, ethyl acetate, methyl acetate or other suitable solvent. The preferred displacement fluid should have a boiling point lower than the sublimation temperature of elemental iodine (I₂). The ideal displacement fluid will have a boiling point below 150° F. A preferred displacement fluid is methyl acetate.

A displacement fluid desorption operation provides a controlled, solvent based method for removing elemental iodine (I₂) from the non-polar adsorption media, and it offers several technical and operational advantages over reductive stripping, thermal desorption, or other regeneration approaches. After the non-polar adsorption media has been fully loaded with elemental iodine (I₂) and preferably cleaned and dried, a displacement fluid is introduced into the adsorption vessel and flowed through the bed of adsorption media at a defined hydraulic loading. As the solvent passes through the media, elemental iodine (I₂) dissolves into the displacement fluid and is transported out of the bed by convective flow. Because elemental iodine (I₂) is highly soluble in a range of moderately polar or non-polar organic solvents, the process achieves rapid mass transfer and high desorption efficiency, typically requiring only 1-2 bed volumes of the displacement fluid to remove essentially all of the retained elemental iodine (I₂). This solvent driven mechanism avoids the chemical complexity and by product formation associated with reductive regeneration, where reducing agents convert elemental iodine (I₂) back to iodide or triiodide, creating additional ionic species that must later be re-oxidized and re-processed. The use of a displacement fluid also avoids the elevated temperatures required for thermal desorption, which can volatilize elemental iodine (I₂), degrade adsorption media performance, and/or impose significant energy demand.

A key advantage of solvent displacement is the ability to select a displacement fluid with a boiling point lower than the sublimation temperature of elemental iodine (I₂), allowing the displacement fluid to be removed by gentle evaporation or low temperature distillation without volatilizing or degrading the elemental iodine (I₂) product. This enables recovery of high purity crystalline elemental iodine (I₂) while preserving the integrity of the adsorption media for repeated use. Without limitation, the displacement fluid may be selected from propane, butane, pentane, hexane, chloroethane, dichloromethane, carbon tetrachloride, ethanol, acetone, dimethyl ether, diethyl ether, methyl tert butyl ether, tetrahydrofuran, ethyl acetate, and methyl acetate. Methyl acetate offers a particularly advantageous profile because it provides high elemental iodine (I₂) solubility, a low boiling point, and favorable handling characteristics, while also being classified as a non-VOC regulated solvent under many regulatory frameworks. This reduces permitting burdens, minimizes environmental compliance requirements, and simplifies on-site storage and emissions management compared to traditional hydrocarbon solvents. The combination of high elemental iodine (I₂) solubility, low boiling point, and non-VOC regulatory status makes methyl acetate an especially effective and environmentally favorable displacement fluid.

Beyond regulatory and operational benefits, solvent displacement provides a clean, closed loop pathway for elemental iodine (I₂) recovery. The iodine-rich displacement fluid stream can be directed to a downstream recovery unit where the displacement fluid is evaporated, condensed, and recycled, while the elemental iodine (I₂) is isolated as a high purity solid or concentrated liquid. This closed loop design minimizes consumption of the displacement fluid, reduces waste generation, and supports continuous operation with minimal downtime. The mild operating conditions also preserve the physical and chemical integrity of the adsorption media, enabling many regeneration cycles without loss of capacity. Together, these advantages make displacement fluid desorption a robust, efficient, and environmentally favorable method for regenerating the hydrophobic non-polar adsorption media and recovering high purity elemental iodine (I₂).

A solvent evaporation unit or vessel 70, such as a distillation column, may be used to separate the displacement fluid from the elemental iodine (I₂). In the solvent evaporation unit, the displacement fluid is evaporated under distillation conditions, such as the application of a controlled temperature and pressure. A distillation column of any of the typical designs can be used to facilitate better separation of the displacement fluid from the elemental iodine (I₂) fluid and/or vapors. The solvent evaporation unit could also be called a solvent recovery unit.

Elemental iodine (I₂) has a relatively high vapor pressure, such that advanced distillation techniques and equipment can be used to ensure that no more than a minimal amount of elemental iodine (I₂) carries over with the vaporized displacement fluid. If some elemental iodine (I₂) carries over, that is not a problem in that the displacement fluid will be recycled and reused, and the amount of elemental iodine (I₂) will remain at a thermodynamic constant so in the continuous process will not contribute to a yield loss. Technical benefits include no volatile organic compound (VOC) loss, minimal energy expenditure and complete recycling of solvent or displacement fluid.

A displacement fluid condensation or recycle unit 80 may be used to condense the evaporated displacement fluid and collect the condensed displacement fluid for reuse in the process. This unit can optionally filter or purify the displacement fluid, as needed. However, the unit 80 may be a simple storage container, or provide the displacement fluid to a separate storage container 90 that holds the until the next round of loaded adsorption unit needs to have the iodine displaced.

The solvent (displacement fluid) distillation and recovery system is an important component in a closed-loop iodine desorption process, designed to efficiently separate and recycle the displacement fluid while isolating high-purity elemental iodine (I₂). Optimal solvent recovery may be performed with control of temperature, pressure, and vacuum conditions to maximize solvent evaporation and condensation efficiency while minimizing elemental iodine (I₂) loss and energy consumption.

The displacement fluid, typically a solvent with a boiling point lower than the elemental iodine (I₂) sublimation temperature, is evaporated under controlled distillation conditions. Operating temperatures are maintained just above the solvent's boiling point, often in the range of 40-70° C. depending on the solvent (displacement fluid) used, to ensure complete vaporization without degrading the quality of the elemental iodine (I₂). A vacuum pressure may be applied to further reduce the boiling point of the displacement fluid, enabling distillation at lower temperatures and preserving integrity of the elemental iodine (I₂).

A distillation column, such as a packed or tray column, is commonly employed to enhance separation efficiency between the solvent vapor and elemental iodine (I₂) vapors. Tray columns may include bubble cap, sieve, or valve trays, each providing different vapor-liquid contact efficiencies and pressure drops. Packed columns, using random or structured packing materials, offer lower pressure drops and are well-suited for lower liquid flow rates and sensitive separations. A column design facilitates multiple vapor-liquid equilibrium stages, allowing volatile organic compounds (VOCs) and displacement fluid vapors to be effectively separated from elemental iodine (I₂), which has a relatively high vapor pressure but lower volatility under these conditions. Iodine's relatively high vapor pressure may be addressed using advanced distillation techniques to minimize carryover with the displacement fluid vapor. Advanced distillation techniques such as fractional distillation, vacuum distillation, and use of reflux condensers may be implemented to ensure that the elemental iodine (I₂) remains in the concentrated residue or crystallizes out, while the vaporized displacement fluid is purified for reuse.

The system may be designed to maintain a thermodynamic equilibrium where any minor iodine carryover in the solvent vapor does not accumulate or cause yield loss, as the solvent is continuously recycled. This equilibrium ensures that the elemental iodine (I₂) concentration in the solvent remains constant, preventing degradation of product purity or process efficiency.

The evaporated displacement fluid or solvent is preferably condensed in a dedicated condenser unit, typically using cooling water or chilled glycol systems, to recover the displacement fluid in liquid form. The condensed displacement fluid is collected in a storage or buffer tank, where it may undergo optional filtration or purification steps to remove any residual impurities before being reintroduced into the displacement fluid feed.

A closed-loop solvent recycle system minimizes solvent consumption, reduces environmental emissions, and lowers operational costs. The system is engineered to prevent VOC losses by maintaining sealed connections, controlled vacuum levels, and efficient condensation, aligning with environmental compliance requirements. Energy efficiency is optimized by operating under vacuum to lower distillation temperatures and by integrating heat recovery systems where feasible. The choice of solvent with favorable boiling point and regulatory status, such as methyl acetate, further reduces energy demand and environmental impact. Overall, the solvent distillation and recovery system ensures high solvent purity, minimal iodine loss, and sustainable continuous operation, making it a vital part of the iodine desorption and recovery process.

An iodine collection and vaporization chamber 100 may be provided to collect and further purify the elemental iodine (I₂). Once the displacement fluid has been separated from the elemental iodine (I₂), the elemental iodine (I₂) remains in the form of a liquid and/or a solid. For example, the collected elemental iodine (I₂) may be in the form of a slurry of iodine crystals and liquid, dissolved iodine. The elemental iodine (I₂) crystals (a solid) can be collected and the remaining liquid containing dissolved elemental iodine (I₂) may be heated to the sublimation temperature of iodine. This can be done at atmospheric pressure or under vacuum conditions. The temperature may be closely controlled to first remove any remaining displacement fluid. Once the displacement fluid is gone, the temperature can be increased to 85-110° C. under atmospheric pressure to vaporize water and iodine. The vapor can be cooled and wet iodine crystals created which can be also collected. If vacuum or reduced pressure distillation is used, the temperature may be much lower.

Instead of collecting the crystals from the slurry formed during distillation of the displacement fluid, the entire slurry can be heated to 85-120° C. which is the temperature where iodine readily vaporizes or sublimes and the wet crystals are formed and collected. This may be preferred because any non-volatile impurities that might co-precipitate with the iodine would be eliminated and left in the distillation chamber. The resultant product from this step will be sub-technical grade due to the amount of water. This wet iodine could be sold as a product or further purified.

When the displacement solvent has been fully removed from the iodine-rich mixture, the remaining material separates into a heterogeneous slurry composed of solid elemental iodine (I₂) crystals and a liquid phase containing dissolved elemental iodine (I₂) in water. The removal of the displacement fluid alters the solubility conditions of the system, causing a portion of the elemental iodine (I₂) to precipitate as discrete crystalline solids while the remainder remains in solution as elemental iodine or as iodine water complexes. In one embodiment, the solid crystals that form during this solvent removal stage may be isolated from the slurry through any suitable solid-liquid separation technique, after which the remaining liquid containing dissolved elemental iodine (I₂) may be subjected to a controlled vapor phase transition in which water and elemental iodine (I₂) enter the vapor phase and subsequently condense on a cooled surface to form a new population of elemental iodine (I₂) crystals. In an alternative embodiment, the initially formed crystals are not removed but instead the entire slurry, consisting of both the solid iodine fraction and the iodine bearing aqueous phase, may be exposed to conditions that allow elemental iodine (I₂) to transition directly into the vapor phase from both the solid and dissolved states. This approach conceptually reduces the likelihood that nonvolatile impurities become incorporated into the collected iodine, because such impurities remain in the chamber while only elemental iodine (I₂) participates in the vapor phase transport and re-crystallization. In either embodiment, a small amount of an oxidizing agent may be introduced to convert any ionic iodine compounds that may be re-formed back into elemental iodine, ensuring that all iodine present is in a vapor transferable form and preventing loss of elemental iodine (I₂) to nonvolatile ionic iodine compounds or species. The condensed material produced from either pathway typically forms as moist or “wet” iodine crystals due to the presence of water vapor in the condensation environment, and this wet iodine may be collected as a sub technical grade product or subjected to additional purification steps depending on the desired final purity. The elemental iodine (I₂) at this stage will be very pure except for the amount of water present. The wet iodine at this stage may be salable, if water is acceptable in the application.

An iodine desiccation or drying unit 110 may be provided to dry the collected elemental iodine (I₂) and produce 85-95% pure flake or crystalline iodine. Elemental iodine (I₂) can be dried through several well-established laboratory approaches, each chosen to balance moisture removal with the need to minimize sublimation losses. A common and gentle method is desiccator drying, where iodine crystals are spread in a shallow dish and placed in a sealed desiccator over a strong drying agent such as concentrated sulfuric acid, phosphorus pentoxide, molecular sieves, calcium chloride, or silica gel. This desiccation may be performed at room temperature and is slow but safe, especially if the desiccator is kept cool to limit iodine vapor.

When both drying and purification are desired, sublimation may be preferred. The wet iodine is gently warmed so that it sublimes away from residual water and non-volatile impurities, then redeposits as dry, lustrous crystals on a cold surface such as a chilled condenser or an inverted flask packed with ice. Vacuum drying is another option, using a vacuum desiccator or low-temperature vacuum oven to remove moisture under reduced pressure, though conditions should be carefully controlled because iodine sublimes readily under vacuum. Another process is desiccation using heated, anhydrous sulfuric acid. The iodine will form a separate layer, and the residual water will be pulled into the sulfuric acid. This sulfuric acid can be regenerated and reused. Yet another approach is to heat the iodine above its sublimation temperature in dry gas or air. By flowing the vaporized iodine vapors across a carefully controlled plates or fingers, the iodine will preferentially deposit and the water will not. The expected product from this step will be 85-95% pure elemental iodine (I₂). Across all desiccation pathways, the expected product is a partially dried iodine material typically achieving 85-95% purity, depending on the initial moisture content and the specific drying mechanism employed. The resulting iodine may be collected as flakes, crystals, or compacted solids and may be sold as a sub technical grade product or subjected to additional purification steps such as re sublimation, recrystallization, or further drying to achieve higher purity levels.

Further purification operations or units 120 may be provided to obtain >99.5% pure elemental iodine (I₂), which is suitable for pharmaceutical applications. Following desiccation, the iodine may be further processed by a second or even a third vaporization or re-sublimation to deposition to increase the purity. This will make >99.5% pure iodine which is suitable for pharmaceutical applications. This will be carried out in a separate unit from the technical grade material.

Achieving ≥99.5% pure elemental iodine (I₂) through re-sublimation may involve repeatedly volatilizing and re-depositing iodine at temperatures centered around its sublimation point, with the process operated about 10° C. above the natural sublimation temperature of iodine to ensure complete vaporization while still maintaining strong selectivity against nonvolatile impurities. Iodine normally sublimes at approximately 113° C., so the purification zone in a high purity sublimation unit is typically maintained in the range of 115-125° C. At these temperatures, elemental iodine transitions cleanly into vapor, while inorganic salts, trace metals, and organic residues remain as solids. The desiccated technical grade iodine is placed in a uniformly heated chamber constructed from corrosion resistant materials, and the controlled thermal environment ensures that only iodine enters the vapor phase. The elemental iodine (I₂) vapor then migrates through a clean, inert pathway toward a deposition surface held well below the sublimation temperature (often in the 20-40° C. range) to promote efficient condensation and the formation of large, plate like crystals with minimal occluded impurities.

The first sublimation cycle removes the majority of remaining nonvolatile contaminants, leaving a residue of salts and trace solids in the feed zone. The collected crystalline iodine is then subjected to a second sublimation cycle at the same controlled temperature, again operating roughly 10° C. above the sublimation point to maintain selective volatilization without overheating. A third cycle may be used when pharmaceutical grade purity is required. Each cycle further sharpens the separation because the remaining impurities have even lower volatility relative to iodine and are increasingly excluded from the vapor phase. The repeated vapor-solid transitions progressively improve purity, color, and crystal morphology, and by the second or third cycle the iodine consistently reaches or exceeds 99.5% purity. The final elemental iodine (I₂) product is handled exclusively within the high purity unit to prevent cross contamination, gently removed from the deposition surface, screened if necessary, and packaged in sealed, light resistant containers to preserve its purity and minimize sublimation losses during storage.

A significant technical benefit of the system in FIG. 1 and described herein is the regeneration of the non-polar adsorption media back to its original capacity for the capture of elemental iodine (I₂), allowing the adsorption media to operate through many adsorption-desorption cycles without loss of performance. This regeneration can be carried out through two distinct but complementary approaches. In the first approach, the displacement fluid remaining in the adsorption media after iodine desorption may be removed by applying gas flow, warm gas, vacuum, or a combination of these evaporative forces. Dry air or inert gas is passed through the bed to volatilize the solvent, and applying a vacuum lowers the effective boiling point of the displacement fluid, thereby accelerating evaporation even at mild temperatures. The evaporated displacement fluid is carried out of the adsorption media (column or chamber), condensed, and recovered. As the adsorption media becomes fully dry, its surface can become overly hydrophobic, preventing a subsequent aqueous brine solution from re-wetting the pore structure. A small amount of alcohol or mild surfactant solution may be introduced to reduce interfacial tension and restore proper wetting, followed by a rinse with clean water or dilute aqueous brine to remove the conditioning agent and return the media to full adsorption readiness.

In the second approach, the regeneration step begins by flowing clean water through the media to hydraulically displace the displacement fluid. The advancing waterfront pushes the displacement fluid (solvent) out of the pore network and carries it to the outlet as a water-solvent mixture. This mixture is collected and sent to a recovery system where the displacement fluid is separated from the water by distillation, performed either at ambient pressure or under reduced pressure using vacuum to lower the boiling point and reduce energy demand. After the bulk solvent has been displaced and recovered, the non-polar displacement media may still contain a thin solvent film and residual moisture, which may be removed by a short drying step using airflow, warm gas, or vacuum. As in the first approach, the media may become excessively hydrophobic after complete drying, and a small dose of alcohol or surfactant solution may be used to re-wet the surface of the adsorption media and restore full pore accessibility. A final rinse with clean water or dilute brine removes the re-wetting agent and prepares the bed of adsorption media for renewed iodine capture operation.

Both approaches achieve the same outcome of complete restoration of the media's initial iodine adsorption capacity. However, these two approaches differ in whether the removal of the displacement fluid is driven primarily by evaporation or by hydraulic displacement. Each method provides operational flexibility depending on the properties of the displacement fluid, energy considerations, and system design.

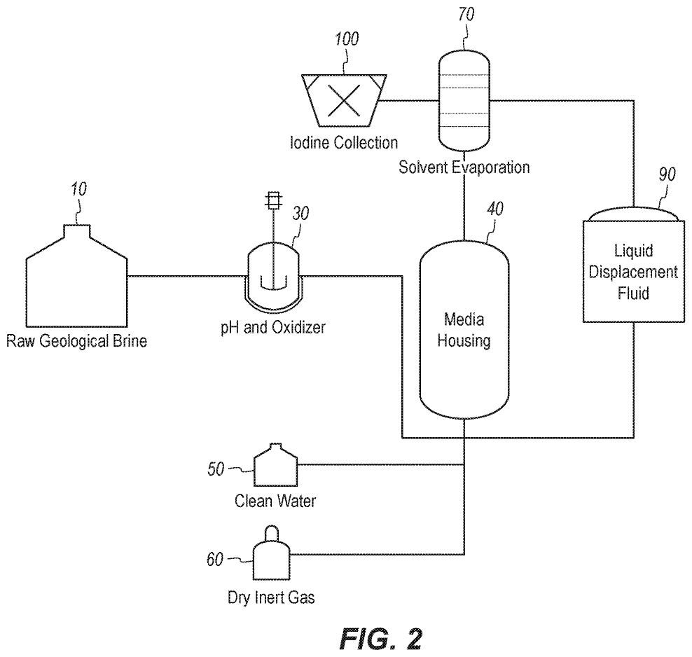

FIG. 2 is a diagram of a simplified system for processing an aqueous brine solution that contains ionic iodine and collecting a concentrated elemental iodine product according to some embodiments. There are substantial similarities between the simplified system shown in FIG. 2 and the system shown in FIG. 1. However, the present diagram is intended to emphasize that the configuration of a system for processing an aqueous brine solution and producing elemental iodine may be customized for a given implementation. For example, if the source of aqueous brine solution does not contain any significant amounts of suspended solids and/or water insoluble hydrocarbons, then the system may omit one or more of the pretreatment operations, such as a filtration operation. In another example, if the final product does not need to have the highest purity or the purification operations are to be performed in another system, then the system may omit the one or more of the purification operations, such as desiccation. Still further, it may be possible to combine one or more operations into a single operation or operational unit, such as combining the condensation and storage of the displacement fluid into a single operation or vessel. These and other modifications of the system in FIG. 1 may be made to simplify the system or adapt the system to a given implementation. However, the operations shown in FIG. 2 may be considered to be the same or similar to those operations described in reference to FIG. 1 and the previous description of these operations may be considered to be equally applicant to present operations.

FIG. 3 is a schematic diagram of the surface of an adsorption material that is modified with one or more alkyl siloxy substituents according to some embodiments. A high surface area silica or other substrate may be modified as described. The “X” represents a either a chlorine atom or a bromine atom.

In this illustration, a tri-alkyl chloro-silane (where X is Cl) is reacted with a silanol group (only the —OH group is shown) on the silica surface. During the reaction, a molecule of HCl (hydrochloric acid) is eliminated and a silicon-oxygen bond is formed. Optionally, HBr (hydrogen bromide) could be eliminated (where X is Br). In some embodiments, the alkyl siloxy substituents correspond to the formula:

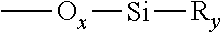

where R is independently a branched, linear or aromatic hydrocarbon containing up to about 30 carbons, x is 1 or 2, y is 2 or 3 and the total of x and y is 4. These bonds are very stable and siloxane materials are very stable chemically compared to carbon. Carbon can easily undergo oxidation to form polar groups on the surface. Silicon in these siloxane materials are already fully oxidized and are thus very stable. This stability provides two important technical benefits to the various embodiments. First, the adsorption material is infinitely regenerable, and the chemical makeup of the non-polar tri-alkyl groups can be optimized for adsorption of different non-polar molecules such as iodine.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “for example,” “without limitation”, “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

What is claimed is:

1. A method, comprising:
converting one or more ionic iodine compounds within an aqueous brine solution to elemental iodine;
passing the aqueous brine solution containing the elemental iodine through a solid non-ionic adsorption media, wherein the elemental iodine is adsorbed out of the aqueous brine solution onto the solid non-ionic adsorption media;
passing a non-polar displacement fluid through the solid non-ionic adsorption media that is loaded with the elemental iodine, wherein the elemental iodine releases from the non-ionic adsorption media and dissolves into the non-polar displacement fluid; and
separating the elemental iodine from the non-polar displacement fluid.

2. The method of claim 1, further comprising:
removing dissolved iron, suspended solids and/or water insoluble hydrocarbons from the aqueous brine solution prior to converting the one or more ionic iodine compounds within the aqueous brine solution to elemental iodine.

3. The method of claim 2, wherein after removing the dissolved iron, suspended solids and/or water insoluble hydrocarbons from the aqueous brine solution, the aqueous brine solution contains less than 1 ppm of the dissolved iron, less than 1 ppm of the suspended solids and less than 1 ppm of the water insoluble hydrocarbons.

4. The method of claim 2, wherein removing suspended solids and/or water insoluble hydrocarbons from the aqueous brine solution includes:
forming a positive oxidation-reduction position within the aqueous brine solution;
causing the aqueous brine solution to have pH is greater than 5.5; and
clarifying, after forming the positive oxidation-reduction potential and causing the aqueous brine solution to have a pH greater than 5.5, the aqueous brine solution by flotation, settling, microfiltration and/or ultrafiltration.

5. The method of claim 4, wherein the aqueous brine solution is clarified by ultrafiltration to less than 60 nanometers.

6. The method of claim 4, wherein converting the one or more ionic iodine compounds within the aqueous brine solution to elemental iodine includes:
adding an acid to the aqueous brine solution to cause the aqueous brine solution to have a pH less than 4.5; and
adding an oxidizer into the aqueous brine solution, wherein the pH less than 4.5 and the oxidizer cause the one or more ionic iodine compounds within the aqueous brine solution to be converted to elemental iodine.

7. The method of claim 1, wherein converting the one or more ionic iodine compounds within the aqueous brine solution to elemental iodine includes:
adding an acid to the aqueous brine solution to cause the aqueous brine solution to have a pH less than 4.5; and
adding an oxidizer into the aqueous brine solution, wherein the pH less than 4.5 and the oxidizer cause the one or more ionic iodine compounds within the aqueous brine solution to be converted to elemental iodine.

8. The method of claim 7, wherein the acid is added to the aqueous brine solution to cause the aqueous brine solution to have a pH less than 2.5.

9. The method of claim 7, wherein the oxidizer is added into the aqueous brine solution in an amount between 1.0 and 5.0 times the molar amount required to oxidize the iodide present in the aqueous brine solution.

10. The method of claim 1, further comprising:
rinsing the solid non-ionic adsorption media that is loaded with elemental iodine with clean water to remove ionic and water-soluble impurities from the solid non-ionic adsorption media.

11. The method of claim 10, further comprising:
passing a dry inert gas through the solid non-ionic adsorption media to remove water that remains on the solid non-ionic adsorption media after rinsing the solid non-ionic adsorption media, wherein the solid non-ionic adsorption media that is loaded with elemental iodine is rinsed and dried prior to passing the non-polar displacement fluid through the solid non-ionic adsorption media.

12. The method of claim 1, wherein the displacement fluid has a high solubility for elemental iodine and has a boiling point below 200° F. at ambient pressure.

13. The method of claim 1, wherein the displacement fluid is diethyl ether, methyl tert-butyl ether, ethyl acetate, methyl acetate, tert-butyl acetate, dimethyl ether, methyl ethyl ether, tetrahydrofuran, dichloromethane and/or tetrachloromethane.

14. The method of claim 1, wherein the displacement fluid is diethyl ether, methyl acetate and/or tert-butyl acetate.

15. The method of claim 1, wherein separating the elemental iodine from the non-polar displacement fluid includes:
vaporizing the displacement fluid without vaporizing the elemental iodine; and
removing the vaporized displacement fluid from contact with the elemental iodine.

16. The method of claim 15, further comprising:
condensing the vaporized displacement fluid in a separate vessel from the elemental iodine, wherein the condensed displacement fluid in the separate vessel is subsequently recycled to be reused to flow through the solid non-ionic adsorption media that is loaded with the elemental iodine.

17. The method of claim 1, wherein separating the elemental iodine from the non-polar displacement fluid includes:
vaporizing the non-polar displacement fluid at a temperature between 0 and 18° F. above the boiling point of the displacement fluid and collecting the condensed displacement fluid in a collection chamber;
vaporizing the elemental iodine at a temperature between 185 and 225° F.;
condensing the elemental iodine on a surface cooler than 194° F. to form elemental iodine crystals; and
collecting the elemental iodine solids.

18. The method of claim 1, wherein the solid non-ionic adsorption media includes a substrate including a polymer of divinyl benzene, styrene and/or siloxane.

19. The method of claim 18, wherein the substrate is functionalized with alkyl groups, aromatic groups, substituted alkyl groups and/or substituted aromatic groups.

20. The method of claim 19, wherein the solid non-ionic adsorption media has a pore size between 50 and 500 angstroms.

21. The method of claim 19, wherein the solid non-ionic adsorption media has a surface area that is greater than 300 square meters per gram (m²/g).

22. The method of claim 1, wherein the solid non-ionic adsorption media includes a styrene divinylbenzene polymer functionalized with aromatic groups.

23. The method of claim 22, wherein the aromatic groups are substituted with bromine.

24. The method of claim 1, wherein the solid non-ionic adsorption media includes silica gel or siloxane polymer media having a surface that has been modified with an alkyl or aromatic groups.

25. The method of claim 18, wherein the solid non-ionic adsorption media includes a styrene divinylbenzene polymer.

26. The method of claim 25, wherein the styrene divinylbenzene polymer is functionalized with bromine.

27. The method of claim 26, wherein the solid non-ionic adsorption media has a pore size between 50 and 500 angstroms and a specific surface area that is greater than 300 square meters per gram (m²/g).

28. The method of claim 1, further comprising:
monitoring a concentration of elemental iodine in an effluent brine solution that has been passed through the solid non-ionic adsorption media, wherein the aqueous brine solution containing the elemental iodine continues to be passed through the solid non-ionic adsorption media until the concentration of elemental iodine in the effluent brine solution exceeds an elemental iodine concentration setpoint.

29. The method of claim 1, wherein the solid non-ionic adsorption media is regenerable.

30. The method of claim 29, further comprising:
after passing the non-polar displacement fluid through the solid non-ionic adsorption media that is loaded with the elemental iodine to release the elemental iodine from the non-ionic adsorption media and dissolve the elemental iodine into the non-polar displacement fluid, passing an additional amount of the aqueous brine solution containing the elemental iodine through the solid non-ionic adsorption media, wherein an additional amount of the elemental iodine is adsorbed out of the additional amount of aqueous brine solution onto the solid non-ionic adsorption media.
